(19) United States
(12) Patent Application Publication
(10) Pub. No.: US 2015/0022818 A1
(43) Pub. Date: Jan. 22, 2015

(54) LASER-DRIVEN OPTICAL GYROSCOPE WITH PUSH-PULL MODULATION

(71) Applicant: The Board of Trustees of the Leland Stanford Junior University, Palo Alto, CA (US)

(72) Inventors: Seth Lloyd, Stanford, CA (US); Michel J.F. Digonnet, Palo Alto, CA (US); Shanhui Fan, Stanford, CA (US)

(21) Appl. No.: 13/912,139

(22) Filed: Jun. 6, 2013

Related U.S. Application Data
(60) Provisional application No. 61/657,657, filed on Jun. 8, 2012.

(51) Int. Cl. G01C 19/66; G01C 25/00

(52) U.S. Cl. CPC G01C 19/66; G01C 25/00
USPC 356/460

(57) ABSTRACT

A system and method for reducing coherent backscattering-induced errors in an optical gyroscope is provided. A first time-dependent phase modulation is applied to a first laser signal and a second phase modulation is applied to a second laser signal. The phase-modulated first laser signal propagates in a first direction through a waveguide coil and the phase-modulated second laser signal propagates in a second direction opposite the first direction through the waveguide coil. The first time-dependent phase modulation is applied to the phase-modulated second laser signal after the phase-modulated second laser signal propagates through the waveguide coil to produce a twice-phase-modulated second laser signal. The second time-dependent phase modulation is applied to the phase-modulated first laser signal after the phase-modulated first laser signal propagates through the waveguide coil to produce a twice-phase-modulated first laser signal. The twice-phase-modulated first and second laser signals are transmitted to a detector.

### CROSS-REFERENCE TO RELATED APPLICATIONS

This application claims the benefit of priority to U.S. Provisional Appl. No. 61/657,657, filed Jun. 8, 2012 and incorporated in its entirety by reference herein.

### BACKGROUND

1. Field of the Application

The present application relates generally to optical gyroscopes, and more specifically, to optical gyroscopes utilizing a laser source.

2. Description of the Related Art

Since the initial theoretical and experimental demonstration of the fiber optic gyroscope (FOG) by Vali and Shorthill in 1976, the fiber-optic gyroscope (FOG) has become the most commercially successful fiber sensor, with several major manufacturers shipping tens of thousands of units annually worldwide. Intense research efforts throughout the 1980s and early 1990s focused on minimizing parasitic errors due to Rayleigh backscattering, the nonlinear Kerr effect, polarization-induced non-reciprocity, Shupe effect, and other lesser sources of error. The development of advanced closed-loop signal processing schemes combined with the excellent performance of modern polarization-maintaining fibers and multifunction integrated optical circuits led to further performance gains. As a result of these efforts, modern FOGs now achieve bias drift and angular random walk (ARW) noise performance matching or even superior to the drift and noise performance of competing inertial navigation technologies such as ring laser gyroscopes.

The resounding commercial success of the FOG stems to a large degree from the early adoption of a broadband light source to interrogate it, instead of a laser as used in early prototypes. Initial experiments in FOGs were generally conducted with various solid-state lasers with either single-mode or multi-mode operation. However, these experiments and subsequent analysis showed that using coherent light in a FOG leads to three significant sources of parasitic errors (e.g., noise and drift in the sensor output), namely (1) nonlinearity of the propagation constant, dominated by the Kerr effect (nonlinear Kerr-induced drift), (2) polarization errors (polarization-induced drift) caused by coupling between polarization states within the Sagnac interferometer, which has a significant magnitude because of the finite extinction ratio of the polarizer and polarization-mode degeneracy in single-mode fibers, and (3) backscattering in the sensor path, primarily dominated by distributed Rayleigh scattering (coherent backscattering-induced noise and drift). Investigations at the time accurately predicted that while a laser-driven gyroscope can provide a good scale factor stability, these three sources of error would limit the performance of a laser-driven FOG far above inertial navigation requirements.

To mitigate these errors, broadband sources with coherence lengths on the order of 10-100 μm were adopted. Because the FOG is a common-path interferometer, such short coherence lengths destroy the coherence fundamental to these parasitic effects without degrading the primary signal, and a broadband source reduces to negligible levels the sources of noise and/or drift due to the Kerr effect, coherent backscattering, and polarization coupling. (See, e.g., Bohm, K. et al., “Low-drift fibre gyro using a superluminescent diode,” Electron. Lett. 17(10), 352-353 (1981); Lefevre, H. C., Bergh, R. A., Shaw, H. J., “All-fiber gyroscope with inertial-navigation short-term sensitivity,” Opt. Lett. 7(9), 454-456 (1982).)

Thanks to the use of a low-coherence source, commercial FOGs achieve remarkable performance, including a typical angular random walk (ARW) of about 1 μrad/√Hz and a typical long-term drift of 0.1 μrad for a closed-loop system.

However, a broadband source introduced other issues. First, broadband sources exhibit excess noise, which is typically much larger than shot noise, hence the FOG's minimum detectable rotation rate has been limited all these years to values much higher than the shot-noise limit. (See, e.g., Burns, W. K. et al., “Excess noise in fiber gyroscope sources,” Photonics Technol. Letters 2(8), 606-608 (1990).) Second, the mean-wavelength stability of a broadband source is low (typically 10-100 ppm for the Er-doped superfluorescent fiber source (SFS) used in some commercial FOGs), which means that the FOG scale factor, which is inversely proportional to this mean wavelength, is inadequate for high-end applications. These issues, particularly this last one, have limited the FOG's competitiveness compared with other optical gyros for the enormous market of inertial aircraft navigation.

### SUMMARY

Certain embodiments provide a method of reducing coherent backscattering-induced errors in an output of an optical gyroscope. The method comprises splitting laser light into a first laser signal and a second laser signal. The method further comprises applying a first time-dependent phase modulation to the first laser signal to produce a phase-modulated first laser signal. The method further comprises applying a second phase modulation to the second laser signal to produce a phase-modulated second laser signal, the second time-dependent phase modulation substantially equal in amplitude and of opposite phase with the first time-dependent phase modulation. The method further comprises propagating the phase-modulated first laser signal in a first direction through a waveguide coil. The method further comprises propagating the phase-modulated second laser signal in a second direction through the waveguide coil, the second direction opposite to the first direction. The method further comprises applying the first time-dependent phase modulation to the phase-modulated second laser signal after the phase-modulated second laser signal propagates through the waveguide coil to produce a twice-phase-modulated second laser signal. The method further comprises applying the second time-dependent phase modulation to the phase-modulated first laser signal after the phase-modulated first laser signal propagates through the waveguide coil to produce a twice-phase-modulated first laser signal. The method further comprises transmitting the twice-phase-modulated first laser signal and the twice-phase-modulated second laser signal to a detector.

Certain embodiments described herein provide an optical gyroscope comprising a waveguide coil, a source of laser light, an optical detector, and an optical system in optical communication with the source, the optical detector, and the coil. A first portion of laser light propagates from the source, through the optical system, through the coil in a first direction, then through the optical system to the detector, and a second portion of laser light propagates from the source, through the optical system, through the coil in a second direction opposite to the first direction, then through the optical system to the detector. The optical system comprises a first phase modulator in optical communication with a first portion of the coil and configured to apply a first time-dependent phase modulation. The optical system further comprises a second phase modulator in optical communication with a second portion of the coil and configured to apply a second time-dependent phase modulation that is substantially equal in amplitude and of opposite phase with the first time-dependent phase modulation. The optical system can further comprise at least one polarizer in optical communication with the first phase modulator and the second phase modulator.

### BRIEF DESCRIPTION OF THE DRAWINGS

FIG. 1 is a diagram of an open loop laser-driven optical gyroscope in accordance with certain embodiments described herein.

FIG. 2 schematically illustrates an example interferometric optical gyroscope in accordance with certain embodiments described herein.

FIG. 3 schematically illustrates a cross-section of the fiber or waveguide to understand the effect of scale.

FIG. 4A shows the predicted fiber optic gyroscope angular random walk noise as a function of the source coherence length an example set of parameters.

FIG. 4B shows the predicted dependence of the fiber optic gyroscope bias error on the source coherence length for the same gyroscope as in FIG. 4A.

FIG. 4C shows the calculated dependence of the bias error on the backscattering coefficient α_{B} for two laser linewidths.

FIG. 5 shows the dependence of backscattering-induced drift on the loop coupling coefficient for a 10-MHz linewidth source.

FIG. 6 shows the dependence of backscattering-induced drift on the fiber loss for two sources with different linewidths.

FIG. 7 shows an example of an Allan variance plot for a 10-MHz bandwidth DFB laser, along with that from a conventional erbium-doped broadband superfluorescent source (SFS).

### DETAILED DESCRIPTION

Based on insights from a new model of scattering in optical gyroscopes, such as fiber optic gyroscopes (FOGs), using high-coherence sources (e.g., laser sources with linewidths less than 10⁸ Hz or less than 10¹¹ Hz), certain embodiments described herein provide an optical gyroscope driven with a laser of suitable linewidth advantageously exhibits short and long-term performance matching and/or exceed that of the same optical gyroscope driven by a broadband source (e.g., source with bandwidth greater than 10¹¹ Hz). In certain embodiments, the optical gyroscope can be combined with the use of a hollow-core fiber in the sensor coil to produce new optical gyroscopes exceeding current standards.

A laser has two major advantages over broadband sources. Because a semiconductor laser around 1.5 μm has an excellent wavelength stability (typically <1 part per million (ppm)), the issue of scale factor stability would be resolved. A laser also has negligible excess noise compared to a broadband source, which can lead to a much lower angular random walk (ARW) noise contribution. Also, since the initial adoption of broadband sources, there have been intervening improvements in technologies related to optical gyroscopes that impact the selection of the light source. Improvements in the design and manufacturing of the various optical components and the single-mode fiber used in the optical gyroscope have led to much lower system losses. These lower losses reduce the circulating power in the coil, significantly reducing nonlinearities. Additionally, the development of integrated optics and high extinction ratio polarizers, as well as improved polarization-maintaining fibers, diminishes polarization nonreciprocities. While these two error sources are not completely mitigated, these improvements in related technologies raise again the prospect of operating an optical gyroscope with a laser.

As described herein, a reevaluation of the merits of using a laser source in an optical gyroscope has led to certain embodiments described herein, which address the problems that a laser reintroduces, namely coherent backscattering noise and drift, and Kerr-induced drift. Certain such embodiments achieve several important breakthroughs, including a laser-driven optical gyroscope with a record ARW of 0.35 μrad/√Hz, and a laser-driven optical gyroscope with the same Allan variance (AV) curve as an SFS-driven optical gyroscope.

### Modeling of Laser-Driven Solid-Core Optical Gyroscope

The following description addresses the physics of coherent backscattering in a Sagnac fiber loop, and presents modeling of the noise and long-term drift resulting from it. Early models unfortunately either vastly overestimated this noise (see, e.g., Cutler, C. C. et al., “Limitation of rotation sensing by scattering,” Optics Letters 5(11), 488-490 (1980)) or only considered sources with very short coherence lengths (see, e.g., Mackintosh, J. M. and Culshaw, B., “Analysis and observation of coupling ratio dependence of Rayleigh backscattering noise in a fiber optic gyroscope,” J. of Lightwave Technol. 7(9), 1323-1328 (1989)). These predictions, made around the time of the abandonment of the laser as an optical gyroscope source, remained unchallenged until recently largely because broadband sources solved most of the problems.

Fiber gyroscope performance is typically measured using three primary metrics: bias stability (in °/√h), angular random walk (in °/√h), and scale factor stability (in ppm). Because gyroscopes are rate sensors and the output is integrated over time, bias stability is an important metric for quantifying long-term limitations on gyroscope performance. Bias stability can be measured using the Allan variance method, a method first developed for quantifying clock stability. Inertial navigation applications generally utilize a bias stability of 10⁻³°/h or better.

Angular random walk (ARW) is a measure of the white noise component of the sensor output, which affects the short-term sensor performance. For a broadband-source driven optical gyroscope, the ARW is dominated by the inherent beat noise of the frequency components of the source itself, which is known as excess noise. If the excess noise can be reduced, ARW will be limited by the electrical and optical shot noise of the system. Typical broadband-source-driven gyroscopes with excess-noise-limited ARW can achieve an ARW of 10⁻⁴°/√h.

The optical gyroscope scale factor is the constant of proportionality that relates the rotation rate applied to the gyroscope to the induced phase shift in the Sagnac interferometer, as given by:

$$\begin{matrix}Δ φ = {S}_{F} {Ω}_{R} & ( 1 ) \\ {S}_{F} = \frac{2 π LD}{λ c} & ( 2 )\end{matrix}$$

where S_{F} is the scale factor, Δφ is the rotation-induced phase shift between counter-propagating fields in the Sagnac loop, Ω_{R} is the rotation rate, L is the total loop length, λ is the wavelength of the light, and D is the loop diameter. The dependence of the induced phase shift on L, D, and λ leads to errors in rotation-rate measurements due to variations of any of these parameters over time. Some of these parameters are susceptible to variations due to temperature fluctuations, and thermal instability can be the primary source of scale factor errors in any of these temperature-dependent parameters. While good thermal design can reduce instabilities in L and D down to the 1 ppm level, stabilizing the mean wavelength of the broadband sources used in modern optical gyroscopes to this accuracy has proven more challenging. The result is that the best optical gyroscopes generally achieve scale factor stabilities on the order of 10-100 ppm, which is generally insufficient for inertial navigation applications and which is at least one order of magnitude higher than the 1-ppm scale-factor stability of ring laser gyroscopes. For a typical telecommunication laser, fluctuations of the mean wavelength can be stabilized to below 1 ppm.

One possible method for reducing scale-factor instabilities further is to replace the standard broadband source used in an optical gyroscope with a single-mode semiconductor laser. Significant efforts have been made in improving the wavelength stability of these lasers for their applications in dense-wavelength-division-multiplexing systems. The result is that laser wavelength stabilities at the 1-ppm level or better are readily commercially available. Thus an optical gyroscope driven by such a source would eliminate the major source of scale-factor instability in modern broadband-source-driven optical gyroscopes.

Additionally, a laser-driven optical gyroscope may lead to a lower noise system. As is widely known, broadband, incoherent light suffers from noise in excess of the fundamental shot-noise limit. This excess noise limits the performance of all modern fiber optic gyroscopes. Thus, while broadband sources have been successful in reducing the aforementioned deleterious effects, the tradeoff has been that all modern fiber optic gyroscopes continue to suffer from a noise floor well above fundamental limits. Because single-mode lasers do not exhibit this excess noise, using a laser would therefore remove another limit to the performance of modern fiber optic gyroscopes.

Finally, an optical gyroscope driven by a laser would have the further advantages of consuming less power, reducing the system complexity, and reducing the system cost compared to a broadband-source-driven fiber optic gyroscope. The challenge, of course, is overcoming the known parasitic errors induced by using a coherent source in an optical gyroscope, which were largely the reasons for abandoning the use of lasers in fiber optic gyroscopes years ago and adopting broadband sources instead.

Measurements from an optical gyroscope interrogated by a laser with a coherence length longer than the loop length confirm that a laser-driven optical gyroscope can result in a lower noise system (see, e.g., U.S. Pat. No. 7,911,619, which is incorporated in its entirety by reference herein). These measurements show that the fiber optic gyroscope exhibited an angular random walk (ARW) noise performance below the level of the same gyroscope interrogated by a broadband source. This result was in contrast to early observations and predictions of large errors due to coherent light in optic gyroscopes.

The description below provides a theoretical model of the noise and drift in an optical gyroscope interrogated with a source of arbitrary linewidth, focusing on the effects of coherent backscattering, which are expected to be the largest source of error in an optical gyroscope interrogated with coherent light. The theoretical predictions support our earlier reported results and indicate, for the first time, the possibility of a navigation-grade optical gyroscope operated with a single-mode laser rather than a broadband source.

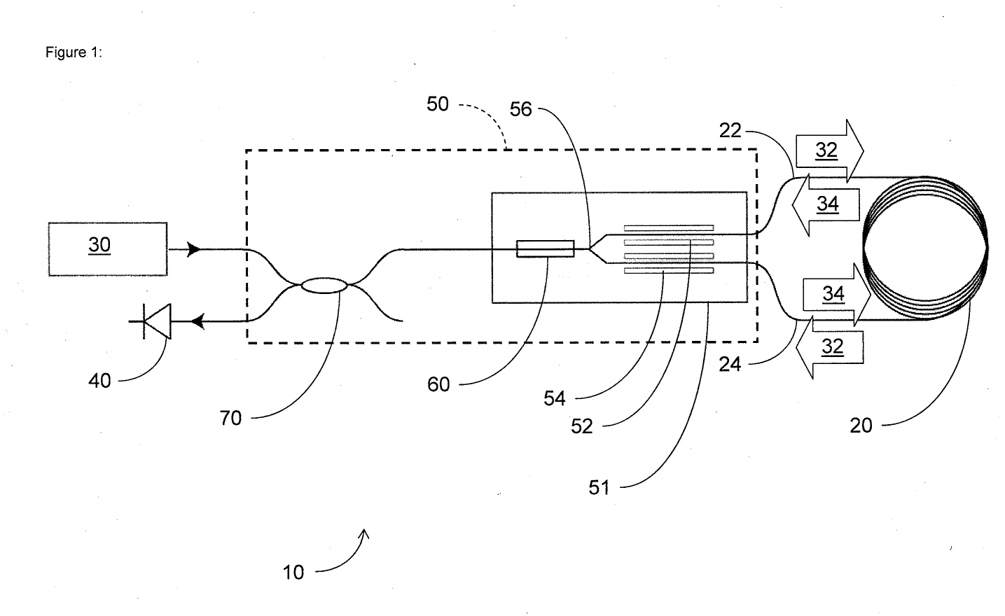

FIG. 1 is a diagram of an open loop laser-driven optical gyroscope 10 in accordance with certain embodiments described herein, U.S. Pat. No. 7,911,619 and U.S. Pat. No. 8,223,340, each of which is incorporated in its entirety by reference herein, provide additional information regarding certain aspects of such optical gyroscopes in accordance with certain embodiments described herein. The laser-driven optical gyroscope 10 of FIG. 1 has a minimum open-loop configuration, but the conventional broadband source is replaced by a single-mode laser. While other modifications are described herein, the optical gyroscope 10 of FIG. 1 can be used to describe the analysis of errors in such optical gyroscopes. The optical gyroscope comprises a laser source 30, a photodetector 40, at least one input/output coupler 70 (e.g., a 2×2 50% coupler or a fiber circulator), an in-line polarizer 60 (e.g., a polarizing waveguide), a loop coupler 56, a pair of phase modulators 52, 54 for biasing, and a coil 20 comprising a plurality of loops and configured with the loop coupler to form a Sagnac loop. These various components can be achieved through either an all-fiber approach or by using integrated optics to combine the functions of the polarizer 60, loop coupler 56, and phase modulators 52, 54 in a single unit. The coil 20 can be made of an optical fiber, such as a polarization-maintaining fiber, or other forms of optical waveguiding structures. Closed-loop signal-processing techniques can also be added, but since operation with a laser rather than a broadband source is not expected to change the benefits of closed-loop operation, without loss of generality only open-loop operation is considered here.

When light is backscattered in the Sagnac loop, photons backscattered within the coil 20 interact with the primary photons. If the light is spectrally broad (very short coherence length L_{c}), only photons scattered near the midpoint of the loop interact coherently and lead to coherent noise. All others interact incoherently and introduce intensity noise, which is typically negligible. When the source has a coherence length equal to or longer than the loop length L, all photons backscattered along the loop interact coherently, and the coherent noise is high. The laser linewidth is a key parameter to be controlled in this interaction. The noise does not originate primarily from fluctuations in the phase or amplitude of the scatterers, but from the phase noise of the laser itself. If the laser had zero phase noise, coherent backscattering would not be an issue, because all the backscattered photons would have a stable phase and thus give rise to a constant, noise-free offset in the output signal, which could be measured and subtracted. Although the phase noise of a laser cannot be zero, the phase noise can be reduced, by orders of magnitude, by reducing the laser linewidth. Coherent backscattering also causes drift. For example, when a section of the sensing coil is exposed to a change in strain or temperature, the backscattered photons traveling through it experience a phase shift. Photons backscattered clockwise (CW) and counterclockwise (CCW) generally travel through this section of coil at different times, and therefore experience a different phase shift. This asymmetry results in temporal variations in the offset signal, and hence in a drift.

A model previously presented by us (see Digonnet, M. J. F., Lloyd, S. W., and Fan, S., “Coherent backscattering noise in a photonic-bandgap fiber optic gyroscope,” Proc. SPIE 7503, 750302-1-75032-4 (2009)) generalizes the formalism of earlier work (see Krakenes, K. and Blotekjaer, K., “Effect of laser phase noise in Sagnac interferometers,” J. of Lightwave Technol. 11(4), 643-653 (1993); K. Takada, “Calculation of Rayleigh backscattering noise in fiber-optic gyroscopes,” J. Opt. Soc. Am. A 2(6), 872-877 (1985)) to a phase-modulated optical gyroscope using a source of arbitrary linewidth. The model calculates the fields backscattered from the primary waves by a distribution of M scatterers evenly distributed along the coil (in this particular implementation of this concept, the coil is a fiber), with a random distribution of phase and amplitude, propagates them through the coil to the loop coupler, and sums all fields (2M backscattered and two primary fields) to obtain a temporal trace of the output, which includes the offset due to backscattering. This calculation is repeated for a large number of distributions of M scatterers, with the same random distribution of phase and amplitude but with a different realization of this statistics. In other words, it models distributions of scatterers that achieve the same average backscattering coefficient but with different distributions of scatterers' phase and amplitudes. The offset is calculated as the average of the offsets over all the fibers. This mean offset provides an upper bound value of the drift induced by coherent backscattering. The standard deviation of the offset's temporal fluctuations provides the noise induced by coherent backscattering.

Backscattering-induced errors (i.e., the noise and the drift) have remained the main source of error in a laser-driven optical gyroscope. Backscattering-induced errors can be reduced using modern components, primarily by operating at a wavelength around 1.55 μm rather than the shorter wavelengths used in original optical gyroscopes, which resulted in much stronger Rayleigh scattering in the fiber. However, even with the benefits of reduced scattering at this longer wavelength, early predictions showed that the backscattering-induced error could still be quite large. (See, Cutler, cited above.) These early predictions set out an upper bound for the backscattering-induced error, but this upper bound turns out to be too unrealistically high to be useful. It had been assumed by many that these early predictions would apply for longer coherence lengths as well (e.g., coherence lengths longer than a few mm).

As originally shown by Cutler (cited above), the backscattering-induced error can be bounded by:

φₑ<2\sqrt{α_{B}L} (3)

where φₑ is the expected phase error due to Rayleigh scattering, α_{B} is the Rayleigh backscattering coefficient of the sensing fiber, and L is the minimum of the fiber length and the source coherence length. Using again a source coherence length of 10 m and a backscattering coefficient at 1.55 μm for a typical single-mode fiber of about 10⁻⁷ m⁻¹, this relation would lead to an expected error on the order of 1 mrad, which is considerably higher than the 0.1-μrad level required for typical inertial navigation applications.

While the analysis of Cutler was insightful for recognizing the potentially limiting effects of scattering on optical gyroscope performance, this analysis does not account for the effects of phase modulation in the loop, of the phase noise of the source, and of the symmetry of light scattered in the CW and CCW directions. As Mackintosh and Culshaw (cited above) showed, under certain conditions the use of modulation and a symmetric coupler can significantly reduce the effects of backscattering. However, this analysis was concerned only with the limited case of relatively short coherence lengths, on the order of 1 mm or less, which is much shorter than a typical loop length (100 m to several km). In such a case, it could rightly be assumed that all the coherent scattering was due to a small section of fiber centered at the loop midpoint. To extend that analysis to address the case of optical gyroscope operation with a single-mode laser, a more thorough theory of backscattering in a phase-modulated optical gyroscope was developed, as described more fully below.

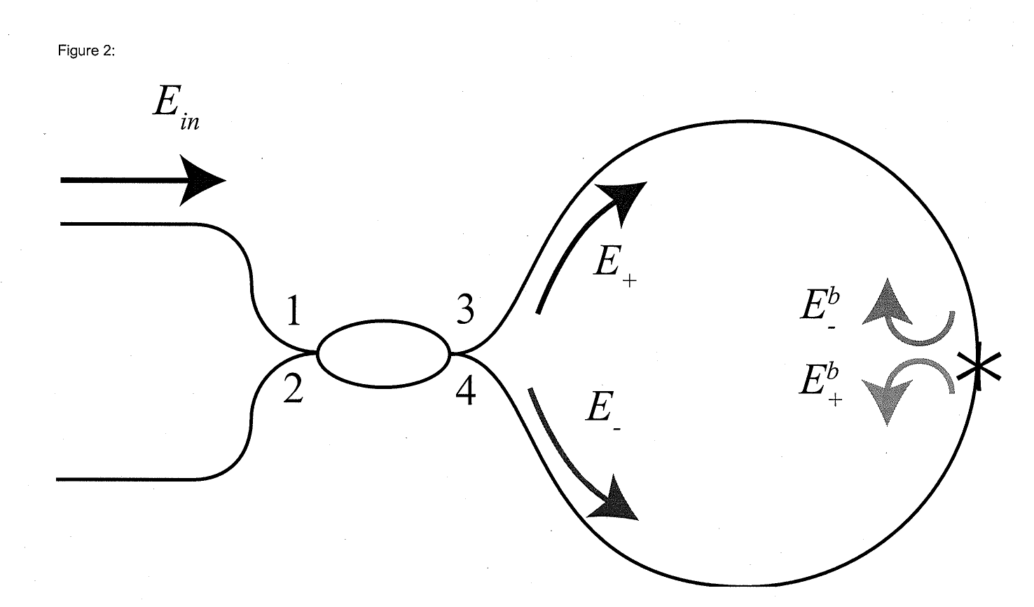

Interferometric optical gyroscopes, such as fiber optic gyroscopes (FOGs), are based on the well-known Sagnac effect. When two beams of light traverse a closed path in opposite directions simultaneously, an angular rotation about an axis perpendicular to the plane of the path induces a differential phase shift proportional to the rotation rate. FIG. 2 schematically illustrates such an interferometric optical gyroscope, in which an input beam is split by a fiber coupler, which launches each beam in the loop in opposite directions, then recombines them on exit at the coupler. Under zero rotation and in the absence of other nonreciprocal and asymmetric time-dependent effects, the optical paths experienced by the two counter-propagating beams are identical, and essentially all the optical power exits at port 1 (essentially because some light is lost due to propagation through the coil): no power comes out of port 2. Rotation breaks this reciprocity and results in each beam experiencing a different optical path, with the difference between the two paths proportional to the rotation rate. Through interference, some of the power then exits at port 2, with a corresponding reduction in the output power at port 1. This power change can be measured and the rotation rate inferred from it.

The effect of backscattering in the fiber coil has been well-documented. When an anomaly exists in the fiber that couples some portion of the traveling light into the reverse direction (E₋^{b} and E₊^{b} in FIG. 2), the backscattered field from each incident direction interferes with the primary fields (E₊ and E₋ in FIG. 2). This interference between backscattered and primary signals can lead to two deleterious effects. First, because the optical paths traversed by the scattered fields in the CW and CCW directions are inherently different, this interference leads to a generally non-zero signal, i.e., a bias error. Non-stationary environmental perturbations of the coil will cause this bias error to fluctuate over time. These environmental perturbations are generally due to either temperature transients or acoustic noise. The bias error fluctuations arising from these perturbations are generally slow compared to the loop delay and give rise to a bias drift, or simply drift, measured in rad or deg/h. This drift is indistinguishable from a rotation-induced change and thus constitutes a source of error.

The second effect also occurs because of the inherent path difference between the primary and scattered fields; however, it arises not from perturbations of the fiber coil, but from inherent random phase fluctuations of the light source. As with any unbalanced interferometer, these phase fluctuations are converted by the path imbalance into random fluctuations in the output, causing additional noise above the shot-noise limit. In a gyroscope, this noise is generally referred to as random-walk noise (rad/√Hz), angle random walk noise (deg/√h), or simply noise. It is the source phase noise, not random variations in the scatterer phase distribution, that causes this backscattering-induced noise in an optical gyroscope.

The two primary sources of backscatter in a solid-core fiber and other optical waveguides are Rayleigh and surface scattering, and scattering due to splices and fiber terminations. When the angle of scattered light is within the acceptance angle of the fiber, this light is coupled into the fiber's forward or backward fundamental modes. For Rayleigh scattering, non-uniform inhomogeneities are randomly distributed along the fiber, and the location and amplitude of the backscattered fields are random processes. The same is true for scattering arising from random fluctuations along the fiber or waveguide length of the fiber or waveguide index profile. For time scales on the order of the loop delay, these processes can be considered stationary in time. Additionally, Rayleigh backscattered light suffers a π/2 phase shift relative to the incident field. While backscattering due to splices and fiber terminations can, in theory, be minimized, backscattering due to Rayleigh scattering and surface defects are inherent properties of solid-core fibers and other waveguides, and they cannot be avoided entirely.

A broadband, highly incoherent light source can be used to overcome the noise and drift caused by backscattering in optical gyroscopes. While incoherent light does not reduce the scattering itself, the very short coherence length of this type of source means that interference between scattered and primary fields is almost completely incoherent. This leads to weaker intensity noise rather than typically large interferometric noise, which translates into a negligible bias error and essentially no bias drift or additional noise due to backscattering. As discussed above, this reduction of backscattering-induced noise comes at the cost of increased instability in the source wavelength as well as an increase in system noise due to the excess noise of broadband sources.

A thorough theory of backscattering in an optical gyroscope can be used to quantify the effects of backscattering when the coherence length of the source is on the order of, or even exceeds, the length of the fiber loop. Several previous reports developed analytic methods and models for predicting the effect of Rayleigh backscattering on the optical gyroscope. Cutler (cited above) performed early work leading to an upper bound on the errors due to backscattering, and building on this work, Takada modeled the effect of backscattering on the noise of the optical gyroscope in the limit of short coherence lengths L_{c} (L_{c}<<L, where L is the loop length) and absent time-dependent phase modulation. (See, Takada, cited above.) Subsequently, Mackintosh (cited above) performed theoretical calculations and demonstrated experimental measurements of the effect of phase modulation and loop coupling ratio on the backscattering-induced errors, again in the limit of L_{c}<<L. Using a different approach, and a novel loop configuration designed for acoustic sensing, Krakenes et al. developed a more robust model of the effect of laser phase noise on the backscattering-induced noise in general Sagnac interferometers. (See, Krakens and Blotekjaer, cited above.) Like previous models, the Krakenes model also assumed a source with a coherence length much shorter than the loop length. Both the Krakenes model and the work of Mackintosh demonstrated the importance of the loop coupling ratio for reducing backscattering-induced errors. Similarly, both Krakenes and Takada predicted an increase in sensor noise with increasing coherence length, at least in the regime of L_{c}<<L. All of these models, together with later models studying the general statistics of Rayleigh backscattering from single-mode fiber, provide a framework for describing the interplay of coherent light and Rayleigh backscatter in an optical gyroscope.

However, to obtain a closed-form solution each of the optical gyroscope models relied on the assumption that the coherence length of the source was much smaller than the loop length. To reconsider the operation of an interferometric optical gyroscope when this approximation fails, a model was developed, as described herein, that does not rely on assumptions about the source coherence length. Additionally, other than the basic calculations performed by Mackintosh, none of these previous models considered the effect of an applied phase modulation in the fiber coil, as used in modern fiber optic gyroscopes. To make predictions absent the assumptions of previous work, the model described below provides a new model of coherent backscattering in an optical gyroscope.

The model begins with the same basic field equations used by both Krakenes and Takada, but considering the optical gyroscope setup shown in FIG. 1. Single-mode operation with a single state of polarization is assumed throughout the fiber, thus scalar fields are used. As illustrated in FIG. 2, the output field from the fiber loop at port 1 has four components, namely, the two primary waves E₊ and E₋ traveling in the clockwise and counterclockwise directions, respectively, and two scattered waves .₊^{.} and E₋^{b}. If the complex input field at port 1 is expressed as .₀.^{.[ω}^{₀}^{.}^{_{.}}^{+φ(.)]}, where ω₀ is the center angular frequency of the source and φ(.) is the source phase noise, then the two primary fields become:

$$\begin{matrix}{E}_{+} ( t ) = {a}_{13} {a}_{41} {E}_{0} {e}^{- α L / 2} {F}_{+} ( t ) & ( 4 ) \\ {E}_{-} ( t ) = {a}_{14} {a}_{31} {E}_{0} {e}^{- α L / 2} {F}_{-} ( t ) & ( 5 ) \\ {F}_{+} ( t ) = exp \{ j [ \begin{matrix}{ω}_{0} \cdot ( t - \frac{L}{v} ) + φ ( t - \frac{L}{v} ) + \\ {φ}_{s} / 2 + {Φ}_{1} ( t - L / v ) + {Φ}_{2} ( t )\end{matrix} ] \} & ( 6 ) \\ {F}_{-} ( t ) = exp \{ j [ \begin{matrix}{ω}_{0} \cdot ( t - \frac{L}{v} ) + φ ( t - \frac{L}{v} ) - \\ {φ}_{s} / 2 + {Φ}_{1} ( t ) + {Φ}_{2} ( t - L / v )\end{matrix} ] \} & ( 7 )\end{matrix}$$

where the ._{..} coefficients represent the complex coupling coefficients between ports n and m of the 2×2 coupler (the coupler is reciprocal, so ._{..}=._{..}), v is the effective phase velocity of the fundamental mode in the fiber, ₛ is the rotation-induced Sagnac phase shift, α is the intensity attenuation coefficient of the fiber, and Φ₁(.) and Φ₂(.) represent the phase modulation imparted by the one or two phase modulators placed in the loop for biasing, depending on the system configuration (two are shown in FIG. 1).

Similarly, the two total backscattered fields can be expressed as:

$$\begin{matrix} {E}_{+}^{b} ( t ) = {a}_{14} {a}_{41} {E}_{0} {F}_{+}^{b} ( t ) & ( 8 ) \\ {E}_{-}^{b} ( t ) = {a}_{13} {a}_{31} {E}_{0} {F}_{-}^{b} ( t ) & ( 9 ) \\ {F}_{+}^{b} ( t ) = {\int }_{0}^{L} j {A}^{*} ( L - z ) exp \{ j [ \begin{matrix}{ω}_{0} \cdot ( t - \frac{2 z}{v} ) + φ ( t - \frac{2 z}{v} ) + \\ {Φ}_{2} ( t - 2 z / v ) + {Φ}_{2} ( t )\end{matrix} ] \} {e}^{- α z} d z & ( 10 ) \\ {F}_{-}^{b} ( t ) = {\int }_{0}^{L} j A ( z ) exp \{ j [ \begin{matrix}{ω}_{0} \cdot ( t - \frac{2 z}{v} ) + φ ( t - \frac{2 z}{v} ) + \\ {Φ}_{1} ( t - 2 z / v ) + {Φ}_{1} ( t )\end{matrix} ] \} {e}^{- α z} d z & ( 11 )\end{matrix}$$

where A(z) is a random variable representing the scattering coefficient at position z. Equations 10 and 11 do not include a Sagnac phase shift, an approximation valid in the limit of even modest rotation rate changes.

Equations 10 and 11 also contain slight but important differences from the formulations used previously by others. Each backscattering coefficient was previously assumed to scatter with a real random amplitude and a fixed phase relative to the incident light of π/2, hence the factor of j. In addition, both the scattering amplitude and phase were previously assumed to be random, with the scattering coefficient represented as a circularly complex Gaussian random variable. This difference in the treatment of the phase of scattered light appears to be attributable to the scale considered.

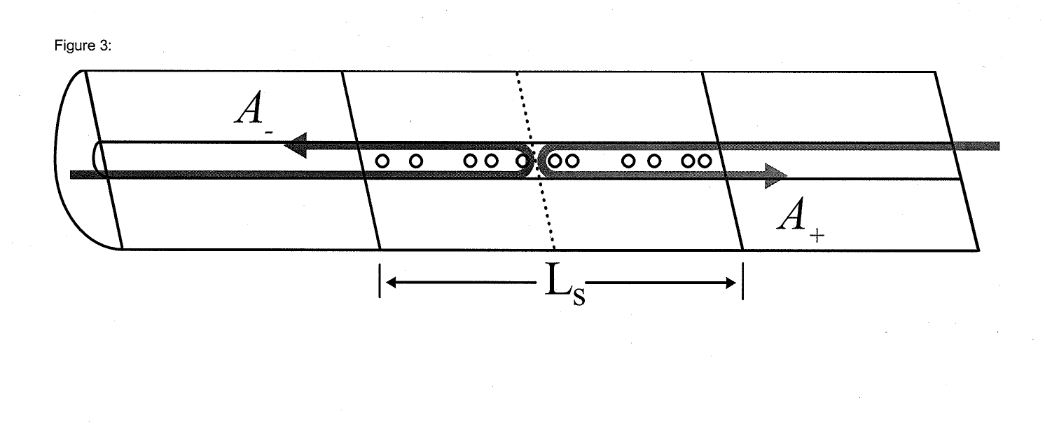

FIG. 3 schematically illustrates a cross-section of the fiber or waveguide to understand the effect of scale. As pictured, if scattering is considered at the microscopic, single scattering level, it has been previously shown for Rayleigh scattered light that the phase of scattered light is a fixed π/2 shift relative to the incident phase, regardless of the direction of incident light. However, if instead scattering is considered at the mesoscopic scale, where scattering from an entire segment of length Lₛ is taken as the sum of all of the scatterers within the region, then the fixed phase of π/2 no longer remains valid. Instead, the random location of the scatterers within the segment means that, in the limit of many scatterers, the complex sum of scatterers results in a complex scattering coefficient with a random phase and amplitude. Because of the fixed π/2 phase shift for each individual scatterer, the random phases are clustered around a mean of π/2. For light incident from the right in FIG. 3, this can be represented by the complex scattering coefficient A₊=jA.

When considering light incident from the opposite direction (from the left in FIG. 3), scatterers are encountered in the reverse order. Absent the fixed π/2 phase shift due to Rayleigh scattering, this would result in a total scattering phase for the region equal to but with opposite sign as that of the original direction. However, because light scattered from each individual scatterer still suffers the same π/2 phase shift, the net effect is a scattering coefficient in the reverse direction A₋=jA*. This formulation is valid at any scale, with changes in scale being reflected in the distribution of the complex scattering coefficient A. At the microscale, used in Krakenes, the coefficient is purely real, while in the mesoscopic scale, the coefficient is complex. For maximum flexibility, the model allows for the possibility that the scattering coefficients may be complex, which proves to be an important allowance for the numerical modeling discussed below.

When using two symmetrically located phase modulators and the push-pull modulation scheme described in more detail below (Φ₁(t)=−Φ₂(t)=Φ(t)), the output intensity from the optical gyroscope can be expressed as:

$${I}_{out} ( t ) = {\vert {E}_{+} + {E}_{-} + {E}_{+}^{b} + {E}_{-}^{b} \vert}^{2} = {I}_{0} \{ 4 {\vert {a}_{14} \vert}^{2} {\vert {a}_{13} \vert}^{2} {e}^{- α L} {cos}^{2} [ {φ}_{2} / 2 + Φ ( t - L / v ) - Φ ( t ) ] + {e}^{- α L / 2} {\vert {a}_{14} \vert}^{2} {a}_{13} {a}_{14}^{*} {F}_{+} ( t ) {F}_{+}^{{b}^{*}} ( t ) + cc + {e}^{- α L / 2} {\vert {a}_{13} \vert}^{2} {a}_{14} {a}_{13}^{* } {F}_{+} ( t ) {F}_{-}^{{b}^{*}} ( t ) + cc + {e}^{- α L / 2} {\vert {a}_{14} \vert}^{2} {a}_{13} {a}_{14}^{* } {F}_{-} ( t ) {F}_{+}^{{b}^{*}} ( t ) + cc + {e}^{- α L / 2} {\vert {a}_{13} \vert}^{2} {a}_{14} {a}_{13}^{* } {F}_{-} ( t ) {F}_{-}^{{b}^{*}} ( t ) + cc + {a}_{14}^{2} {a}_{13}^{* 2} {F}_{+}^{b} ( t ) {F}_{-}^{{b}^{*}} ( t ) + cc + {\vert {a}_{14} \vert}^{2} {\vert {F}_{+}^{b} ( t ) \vert}^{2} + {\vert {a}_{13} \vert}^{2} {\vert {F}_{-}^{b} ( t ) \vert}^{2} \} \qquad ( 12 )$$

where cc represents the complex conjugate of the preceding term. The returning signal of the optical gyroscope is contained in the interference of the primary waves . ₊ and E₋, which is the first term in the sum of Eq. 12. The bias error due to backscattering is dominated by the interference of the primary and backscattered fields, represented in terms 2-5 of Eq. 12, or simplified as:

$$\frac{{I}_{n} ( t )}{{I}_{0} {e}^{- α L}} = {\vert {a}_{14} \vert}^{2} {a}_{13} {a}_{14}^{* } [ {F}_{+} ( t ) + {F}_{-} ( t ) ] {F}_{+}^{{b}^{*}} ( t ) + cc + {\vert {a}_{13} \vert}^{2} {a}_{14} {a}_{13}^{* } [ {F}_{+} ( t ) + {F}_{-} ( t ) ] {F}_{-}^{{b}^{*}} ( t ) + cc \qquad ( 13 )$$

where Iₙ(t) represents the dominant error term in the output intensity. Term 6 in Eq. 12 is the interference between the CW and CCW backscattered fields, while the final term is the intensity of each backscattered field. Because the backscattered fields are expected to be much smaller than either of the primary fields, these two residual terms will be neglected.

Eq. 13 depends on two different independent random processes: the temporal fluctuations of the source phase, represented by φ(t); and the varying amplitude of the scattered fields as a function of distance along the fiber, represented by A(z). The presence of the time-dependent phase modulation Φ(t) causes Iₙ(t) to be a non-stationary random process.

Eq. 13 represents the total error induced by backscattering. However, because the optical gyroscope uses a synchronous detection system, the noise actually measured is only the portion of this bias error that falls within the finite bandwidth of the detection system, centered on the modulation frequency. Thus the expected value of Eq. 13 at the modulation frequency represents the bias error, while the standard deviation of the band-limited version of Eq. 13 within the vicinity of the modulation frequency represents the additional noise induced by coherent backscattering. Obtaining these values from Eq. 13 can be accomplished by calculating the power spectral density of Iₙ(t).

As explained previously, the bias error is not stationary due to time-varying external perturbations of the coil. These temporal perturbations change the relative phases of each of the scattered fields since fields scattered from different points will encounter the perturbation at different times. This changes the magnitude and phase of the resulting complex sum that represents the total scattered field. A brute force calculation of the effect of a temporal perturbation on the backscatter-induced error could, of course, be carried out. However, the problem could no longer be treated as a linear time-invariant system because of the time-varying nature of the perturbation, significantly increasing the complexity of predicting the effect of backscattering. Instead, the standard deviation of the expected bias error across all possible distributions of scatterers can serve as an upper bound on the expected drift. This is so because the standard deviation gives a measure of the expected change in the bias error as both the magnitude and the position of the scatterers is changed, while a time-varying perturbation is expected to change only the phase of the scatterers, which is equivalent to changing only their position. The standard deviation of the expected bias error across all possible distributions of scatterers is readily obtainable from the calculations of the power spectral density of Iₙ(t) discussed above and is used in the discussion below as an upper bound on the expected drift due to backscattering. Symmetric windings—often used to minimize the effect of such perturbations on the primary fields—will not offer the same improvement in the presence of scattering because scattering does not occur symmetrically.

Calculating the power spectral density of Eq. 13 utilizes knowledge of the statistics of the backscattering coefficient A(z) and of the source phase noise φ(t). For a statistically homogeneous medium, such as the glass in optical fibers, and for the length scales under consideration here (z−z′>>λ₀), the autocorrelation of the Rayleigh scattering process is known and is given by:

[symbol]

(A*(z′)(A(z) [symbol] =α_{B}δ(z−z′) (14)

where α is the backscattering coefficient of the fiber and depends on the scattering coefficient of the material and the fiber recapture factor. The delta-correlated nature of this process simplifies significantly the calculation of the intensity noise autocorrelation.

The source phase noise φ(t) is assumed to follow a Wiener-Levy process with stationary independent increments. As such, the statistical distribution of the phase difference between any two points in time along the laser signal depends only on the temporal delay between these two points. This phase difference

$$Δ \text{?} ( t , τ ) = φ ( t + τ ) - φ ( t )$$

$$\text{?} \text{indicates text missing or illegible when filed}$$

is described by the probability density function:

$$\begin{matrix} P ( Δ \text{?} ( t , τ ) ) = \frac{exp ( - Δ \text{?} ( t , τ ) / 2 {σ}^{2} ( τ ) )}{\sqrt{2 π} σ ( τ )} \\ with & ( 15 ) \\ {σ}^{2} ( τ ) = 2 π Δ f \vert τ \vert \\ \text{?} \text{indicates text missing or illegible when filed} & ( 16 )\end{matrix}$$

where Δf is the full-width at half-maximum frequency linewidth of the source spectrum. Furthermore, the phase changes over two non-overlapping time intervals, Δφ₁% [symbol] (t₁τ₁) and Δφ₂% [symbol] (t₂, τ₂), are statistically independent.

Calculation of the power spectral density of Eq. 13 can be carried out via brute force numerical simulations. To simplify this calculation, it is useful to rewrite Eq. 10 and Eq. 11 using the substitution τ=2z/v, giving:

$$\begin{matrix}\begin{matrix}{F}_{+}^{b} ( t ) = \frac{v}{2} {\int }_{- ∞}^{∞} A ( L - \frac{v}{2} τ ) {e}^{j [ {ω}_{0} \cdot ( t - τ ) + φ ( t - τ ) + {Φ}_{2} ( t ) + {Φ}_{2} ( t - τ ) ]} {e}^{- \frac{v α}{2} τ} d τ \\ = \frac{v}{2} {e}^{{jΦ}_{2} ( t )} \cdot [ {A}_{1} ( t ) * {B}_{1} ( t ) ]\end{matrix} & ( 17 ) \\ \begin{matrix}{F}_{-}^{b} ( t ) = \frac{v}{2} {\int }_{- ∞}^{∞} A ( \frac{v}{2} τ ) {e}^{j [ {ω}_{0} \cdot ( t - τ ) + φ ( t - τ ) + {Φ}_{1} ( t ) + {Φ}_{1} ( t - τ ) ]} {e}^{- \frac{v α}{2} τ} d τ \\ = \frac{v}{2} {e}^{{jΦ}_{1} ( t )} \cdot [ {A}_{2} ( t ) * {B}_{2} ( t ) ]\end{matrix} & ( 18 ) \\ {A}_{1} ( t ) = \{ \begin{matrix}A ( L - \frac{v}{2} t ) {e}^{- \frac{v α}{2} t} & 0 < t < \frac{2 L}{v} \\ 0 & otherwise\end{matrix} \} & ( 19 ) \\ {A}_{2} ( t ) = \{ \begin{matrix}A ( \frac{v}{2} t ) {e}^{- \frac{v α}{2} t} & 0 < t < \frac{2 L}{v} \\ 0 & otherwise\end{matrix} \} & ( 20 ) \\ {B}_{1} ( t ) = exp \{ j [ {ω}_{0 } t + φ ( t ) + {Φ}_{1} ( t ) ] \} & ( 21 ) \\ {B}_{2} ( t ) = exp \{ j [ {ω}_{0 } t + φ ( t ) + {Φ}_{2} ( t ) ] \} & ( 22 )\end{matrix}$$

The fiber acts as a linear system with an impulse response dictated by the amplitude of the scatterer at a point z and by the round-trip propagation time and loss between the input to the loop and the scatterer. The input to the system is the phase-modulated light source and the output is therefore the convolution of the input with the impulse response, with the additional phase modulation that occurs as the light exits the loop. Expressing the backscattered fields as a convolution simplifies numerical calculations and allows the fields to be calculated more efficiently using a fast Fourier transform algorithm.

The calculation of the backscattered fields in an optical gyroscope can be carried out using the following iterative process. A single sample function of the source phase noise is first generated at sample points n by using a random number generator and by applying the known Gaussian statistics and the independent increments property. Similarly, a single sample function of the scatterers A(z) is generated at sample points m using the known statistical properties of A(z). Note that the convolutions carried out in Eq. 17 and Eq. 18 place a constraint on the spatial sampling used, namely Δz=vΔt/2.

Once sample functions of A(z) and φ(t) are generated, the primary and backscattered fields can be calculated easily using discretized versions of Eq. 4, Eq. 5, Eq. 17 and Eq. 18. The output intensity is then calculated by taking the modulus squared of the sum of all four field components (first line of Eq. 12). The power spectral density from one iteration is calculated as the modulus squared of the Fourier transform of this output intensity. The entire process is then repeated for different sample functions of the scattering and phase noise. The results of hundreds or thousands of such iterations can then be averaged to give the final result.

Convergence of the result can be established heuristically along three different parameters. First, the total number of time samples N is iteratively increased until increasing the time duration of the simulation further leads to a less than 1% change in the predicted bias error. Next, the spatial sampling size is decreased (or the total number of spatial samples M is increased) until a similar convergence of the predicted bias error is observed for further decreases in the spatial sampling size. Following this, N is again varied and tested to ensure that adjusting M did not alter the convergence of N. Finally, once both N and M are fixed, the expected bias error is repeatedly calculated for unique sample functions of the source phase and the fiber scattering distributions, of lengths N and M respectively. The average of the predicted bias error over all unique distributions of source phase and fiber scattering is calculated and the process is again repeated until changes in the average with additional iterations are again below 1%. This results in an estimate of the bias error due to backscattering. Furthermore, the predicted noise due to backscattering converges much more rapidly than the bias error, thus the same process also yields a reliable estimate of the backscattering-induced noise.

The numerical simulation method presented above can be applied in a straightforward manner and allows maximum flexibility by utilizing a minimum number of assumptions about the system. However, iterating over many different sample functions of A(z) and φ(t) can quickly become computationally intensive. Unsurprisingly, obtaining reasonable convergence of the output values can sometimes take considerable time. To reduce this computation time, a direct analytic solution, described below, can be derived from the above model and used to calculate the autocorrelation of the output noise under specific constraints, namely that the phase modulation has a sinusoidal form, φ(t)=φₘ cos(2πfₘt), and that the frequency used is the so-called proper frequency of the Sagnac loop,

$${f}_{m} = \frac{v}{2 L} ,$$

where φₘ is the modulation depth and v is the effective phase velocity of the fundamental mode (see, Eq. 7). These constraints represent typical operating conditions for a phase-modulated optical gyroscope. The resulting analytic solution therefore gives important insight for the standard operation of an open-loop optical gyroscope.

Beginning with Eq. 13 through Eq. 16, the autocorrelation of Iₙ(t) can be calculated as a sum of two terms, each one of which is an infinite series of products of Bessel functions and various sinusoids:

$${R}_{n} ( t , t + τ ) = 〈 {I}_{n} ( t ) {I}_{n} ( t + τ ) 〉 = 4 {α}_{B} {e}^{- α L} ( {κ}^{3} ( 1 - κ ) + {κ ( 1 - κ )}^{3} {\int }_{0}^{L} d z {e}^{- \frac{1}{{τ}_{c}} ( 2 \vert τ \vert + 2 \vert \frac{2 z - L}{v} \vert - \vert τ + \frac{2 z - L}{v} \vert - \vert τ - \frac{2 z - L}{v} \vert )} {e}^{- 2 α z} \cdot cos ( {ω}_{m} τ ) ( {J}_{0} [ 4 {φ}_{m} sin ( {ω}_{m} \frac{τ}{2} ) cos ( π \frac{z}{L} ) ] \cdot ( {J}_{0 } [ 4 {φ}_{m} sin ( {ω}_{m} \frac{τ}{2} ) ] + • ) + • ) - 8 {α}_{B} {e}^{- α L} ( {{κ}^{2} ( 1 - κ )}^{2} {\int }_{0}^{L} d z {e}^{- \frac{1}{{τ}_{c}} ( 2 \vert \frac{2 z - L}{v} \vert + 2 \vert τ + \frac{2 z - L}{v} \vert - \vert τ \vert - \vert τ + \frac{2 z - L}{v} \vert )} {e}^{- 2 α z} \cdot cos ( {ω}_{m} τ ) ( {J}_{0} [ 4 {φ}_{m} sin ( {ω}_{m} \frac{τ}{2} + π \frac{z}{L} ) cos ( π \frac{z}{L} ) ] \cdot ( {J}_{0 } [ 4 {φ}_{m} sin ( {ω}_{m} \frac{τ}{2} ) ] + … ) + … ) \qquad ( 23 )$$

where κ=|a₁₃|²|a₁₄|², and

$${τ}_{c} = \frac{1}{π Δ f} .$$

The integrals in Eq. 23 can be evaluated numerically for given optical gyroscope parameters. Eq. 23 already represents a time average of the autocorrelation of Iₙ(t), which is non-stationary by virtue of the time-dependent phase modulation. Calculating numerically the Fourier transform of Rₙ(τ) thus yields the desired power spectral density, from which the expected bias error at the modulation frequency and the expected noise in the vicinity of the modulation frequency can be extracted. These numerical calculations yield direct results without any need for averaging, unlike in the numerical simulation, which reduces computation time in many instances by more than two orders of magnitude. Both the numerical and the analytic techniques are powerful tools that can be used to fully understand the effect of backscattering in an optical gyroscope.

Both the numerical simulation method and the analytic solution can be used to model several important effects of backscattering in an optical gyroscope. The two models were used to verify each other, adding confidence to the accuracy of the results. In addition, the numerical model allows a broad exploration of the entire backscattering parameter space. It is straightforward, for example, to set Φ₂(t)=0 and consider how a configuration with a single phase modulator, rather than a push-pull phase modulator, might affect the performance of optical gyroscopes. This model then becomes a powerful tool for optimizing optical gyroscope performance in the presence of backscattering to achieve different performance metrics for a variety of applications. For example, a comparison of a gyroscope configuration in which push-pull modulation is used with a gyroscope configuration in which only a single phase modulator is used can illustrate the reduction of the bias errors due to coherent backscattering achieved by using push-pull modulation.

Four parameters of primary interest are the source coherence, the fiber backscattering coefficient, the fiber loop length, and the input coupling coefficients. The impact of each of these is discussed separately below. For these calculations, an optical gyroscope with the properties of a 150-meter coil of polarization-maintaining fiber is considered. This coil is shorter than typically used for navigation-grade applications. However, this coil length was chosen to match those of an experimental gyroscope used for testing purposes, and the implications of increasing the coil length will be discussed below. Table 1 summarizes the parameter values used in the calculations. The values of Table 1 were chosen to mirror the characteristics of the experimental optical gyroscope that has been tested. The gyroscope parameters are L=150 m, a coil diameter D=3.5 cm, an estimated backscattering coefficient α_{B}=1.6×10⁻⁷ m⁻¹, and λ=1.55 μm. Push-pull phase modulation was assumed, which makes the system more symmetric and reduces the offset. Additionally, the modulation index was selected to maximize the optical gyroscope signal.

TABLE 1

| Optical Gyroscope Parameter | Value | |
|---|---|---|
| Fiber length | 150 | m |
| Modulation index (φₘ) | 0.46 | rad |
| Effective index | 1.468 | |
| Propagation loss | 1.15 | dB/km |

| | |
|---|---|
| Nominal power coupling coefficient | 0.5 |

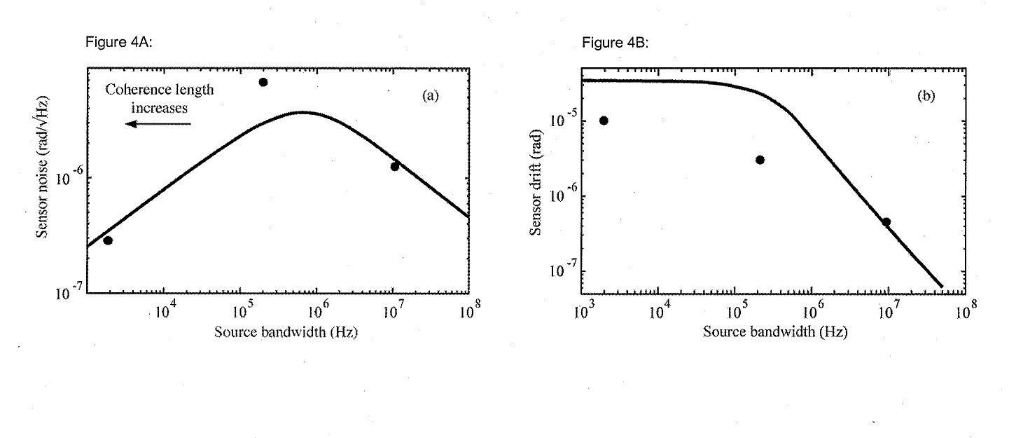

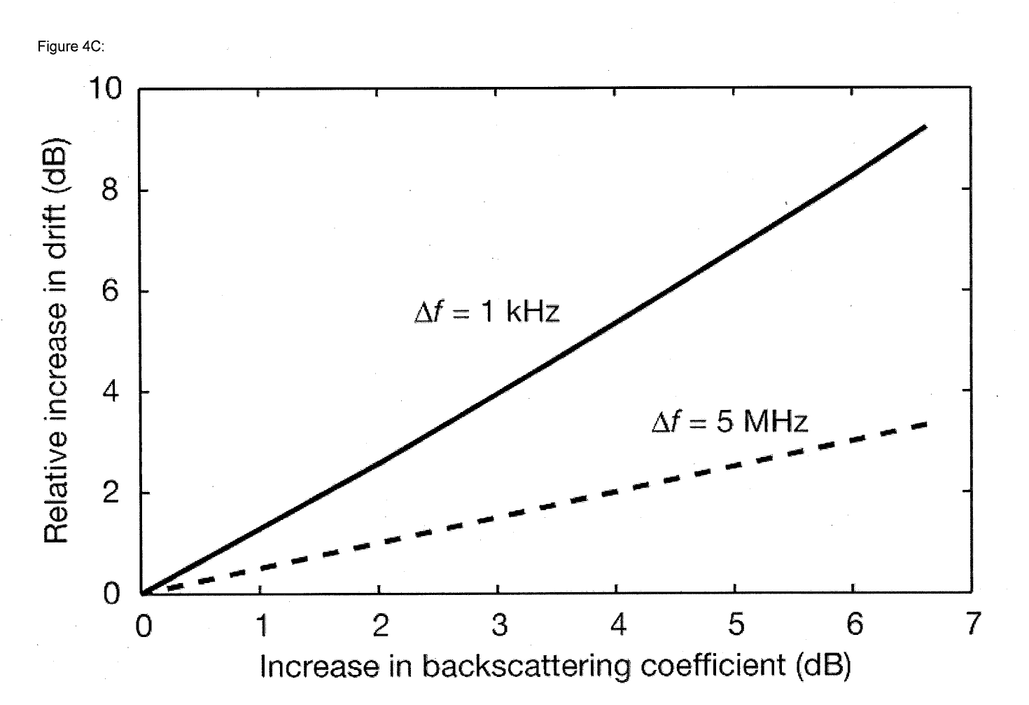

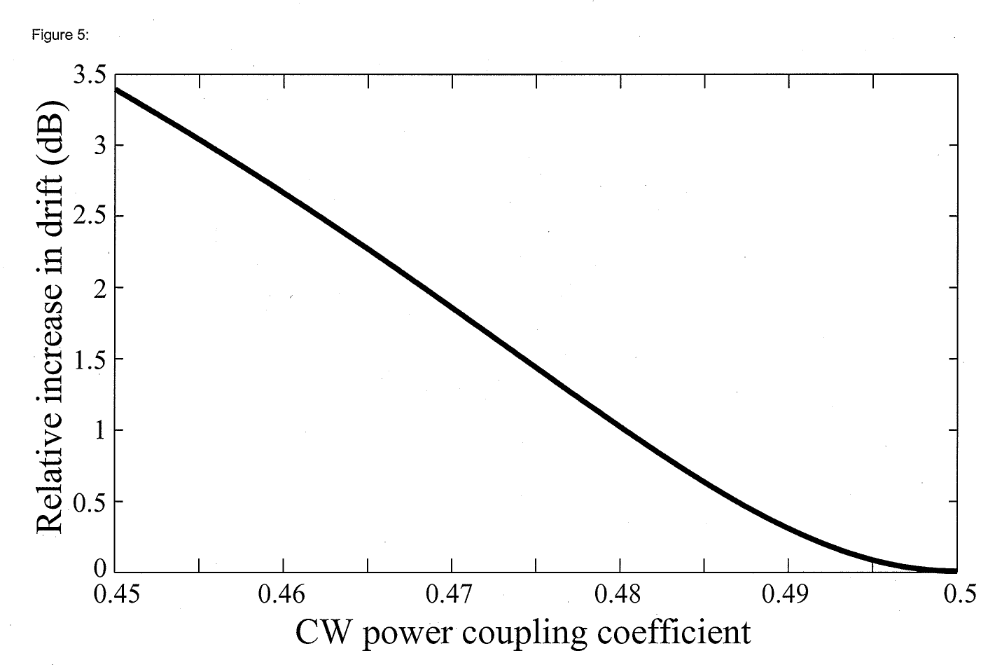

FIG. 4A shows the predicted fiber optic gyroscope angular random walk noise as a function of the source coherence length for the parameters detailed in Table 1. The dependence shows several important characteristics. As the coherence of the source initially increases, the noise increases as well. This makes intuitive sense since coherent scattering can be understood to arise from a length of fiber centered at the midpoint of the coil with length equal to the coherence length of the source. Thus, as the coherence length increases, the number of coherent scatterers increases, leading to larger noise. However, once the coherence length of the source exceeds the loop length, the random walk noise decreases. As the linewidth is decreased from a high value (L_{c}<<L), the noise first increases until L_{c}≈L (L_{c}=L in FIGS. 4A and 4B corresponds to a source bandwidth of about 200 kHz), then it decreases. This decrease occurs for two reasons: first, all available scatterers within the loop are already contributing to the coherent interference, so increasing the coherence length further no longer adds more scatterers; second, as the source coherence length increases, the source phase noise decreases (the phase noise decreases as the linewidth of the laser decreases), leading to diminishing fluctuations of the backscattered signal. By increasing the source coherence length beyond the length of the loop (L_{c}>L), the noise caused by backscattering can be reduced.

FIG. 4B shows the predicted dependence of the fiber optic gyroscope bias error on the source coherence length for the same gyroscope as in FIG. 4A. The bias error, for the same reasons as the noise, initially shows an increase with increasing source coherence (or decreasing source bandwidth). Once the coherence length reaches the loop length (L_{c}=L) and exceeds the loop length, however, the bias drift flattens out and is essentially independent of the source coherence length. This can also be understood intuitively since, as explained previously, once the coherence length exceeds the loop length, all scatterers are effectively interfering coherently with the primary signal. Therefore, as the coherence length increases beyond the loop length, the mean error should not change.

The predicted absolute value for the random walk noise is actually quite low, reaching a maximum of only about 4 μrad/√Hz when the coherence length equals the loop length. The bias error value is also low even for longer coherence lengths (about 30 μrad), though at longer coherence lengths, it is likely too high for more demanding applications, as will be discussed below.

These results point to two possible regions of operation for laser-driven optical gyroscopes, with several potential advantages. The first is the region shown in the left-hand portion of FIGS. 4A and 4B—using highly coherent, very narrow linewidth lasers. Lasers with linewidths in this region will exhibit extremely low ARW noise, much lower than that of a typical broadband source (at about 1 μrad/√Hz). An optical gyroscope driven by a laser in this region would have excellent short-term performance, with the tradeoff being reduced long-term performance due to the large expected drift.

Alternatively, by using a laser with linewidths in the right-hand region of FIGS. 4A and 4B, the laser linewidth can be tailored to achieve both low noise and low drift. Using standard, off-the-shelf telecom lasers with a linewidth of 10-100 MHz, the noise can drop below that obtained with a broadband source, while simultaneously achieving low drift. Drift levels in this region can meet typical requirements for inertial navigation, which usually must be at or below about 0.1 μrad (depending on the scale factor of the optical gyroscope). This low noise and drift comes with the important advantage that the center wavelengths of these lasers can be stabilized below the 1-ppm level.

Note that the modeling in FIGS. 4A and 4B assumes single-mode operation of the source. Source linewidths larger than 100 MHz generally are no longer truly single mode, and the analysis presented here would no longer be applicable. Furthermore, the mean wavelength stability is expected to decrease once the source is no longer single mode. Thus the 10-100 MHz range of source linewidths likely represents the upper limit of relatively broad linewidth lasers applicable for this analysis.

FIG. 4C shows the calculated dependence of the bias error on the backscattering coefficient α_{B} for two laser linewidths. This plot assumes that the loss is dominated by backscattering coefficient (that the fiber loss coefficient scales proportionally to α_{B}, which may not be valid when comparing different fiber types. In such cases, however, the analytic solution makes it straightforward to predict the drift given both the backscattering and loss coefficients.

FIG. 4C shows that for the 5-MHz laser, the drift increases with increasing backscattering coefficient as about √α_{B}. When the linewidth is reduced to 1 kHz, the dependence on α_{B} is more rapid. In other words, increasing the backscattering coefficient has a significant effect on the observed drift for high-coherence lasers, but a smaller effect for low-coherence lasers. The reason is that as the α_{B} increases, the loss also does, and the drift increases more rapidly with increasing loss for a longer coherence laser.

However, when the coherence length is much shorter than the loop length, such as with a source with a 10-MHz linewidth and a loop length in excess of 100 m, all errors due to backscattering are expected to arise from the same short portion of fiber centered at the loop midpoint, regardless of the length of the coil. This implies that increasing the coil length further will not lead to an increase in errors due to backscattering. Rather, both the noise and drift will be reduced by the increasing propagation loss, while the signal will of course increase as before. This implies that longer coil lengths will lead to an improved signal-to-noise ratio. While this assertion is somewhat complicated by the changing modulation frequency, which affects the backscattering errors in complicated ways as explained above, it nevertheless remains valid. Building inertial navigation-grade optical gyroscopes driven with a laser, which require large scale factors, can then generally be achieved by increasing the coil length.

Early investigations of coherent backscattering in optical gyroscopes predicted a strong dependence of the backscattering noise on the loop coupling coefficients. Because backscattered light suffers a π/2 phase shift relative to the primary signal, when the coupling coefficients are exactly 0.5, for an unbiased optical gyroscope, the backscattered signal is mostly in quadrature with the primary signal (limited only by the source coherence), and therefore they do not interfere. The result is a strong cancellation of the backscattering noise as the loop coupling coefficients approach 0.5.

For a sinusoidally biased optical gyroscope, the presence of the phase modulator has the potential to destroy the correlation between the scattered and the primary fields because of the time delay between when each field passes the modulator. However, Culshaw (cited above) showed that the correlation could be maintained in an optical gyroscope with a single phase modulator by operating the modulator at the proper loop frequency (fₘ=v/2L) and using a source with a short coherence length (<1 mm). When the source coherence length is short, all coherent scattering occurs at the loop midpoint, where phase modulation at the proper loop frequency ensures that the scattered fields remain in quadrature with the primary fields. For longer coherence lengths, this correlation would again be destroyed, potentially leading to an increase in backscattering-induced errors.

By biasing an optical gyroscope with dual phase modulators operating in a push-pull configuration, the requisite relation between scattered and primary fields can be restored for much longer coherence lengths. The advantageous effect of the push-pull modulation was not apparent from the previous work of Culshaw (cited above), which deals entirely with short coherence lengths. By operating the modulators at the proper loop frequency (fₘ=v/2L), with a 180° phase difference between the two modulators, an ideal coupler again leads to a cancellation of the backscattered signal. However, rather than the primary and scattered fields being directly in quadrature, the signal resulting from the interference of the primary and scattered fields is modulated in quadrature with the primary signal. Therefore, in a phase sensitive detection process, such as is generally used in optical gyroscopes, the backscattering-induced error can be separated from the primary signal. In fact, for a perfectly coherent source, no error would be expected for a symmetric coupler.

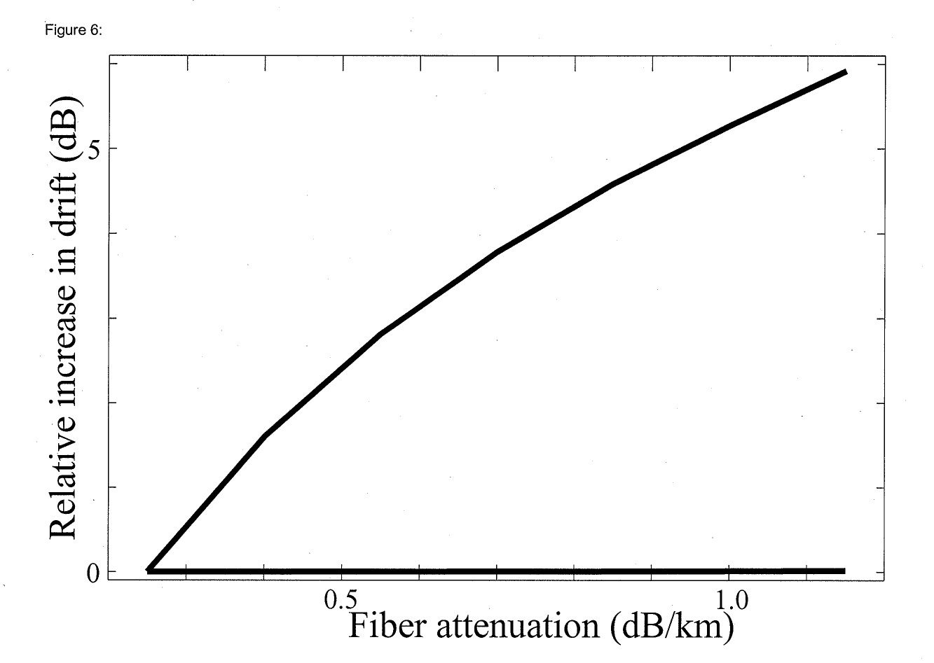

FIG. 5 shows the dependence of backscattering-induced drift on the loop coupling coefficient for a 10-MHz linewidth source. FIG. 5 shows that for a 10-MHz linewidth source, deviation from the ideal coupler will lead to an increase in the expected bias drift, with the expected bias more than doubling as the coupling coefficient goes from 0.5 to 0.45. Thus, even for longer coherence lengths, symmetric coupling and operation at the proper loop frequency lowers the expected backscattering error. FIG. 6 shows the dependence of backscattering-induced drift on the fiber loss for two sources with different linewidths. The lower curve represents a source with a 5-MHz linewidth, while the upper curve represents a source with a 1-kHz linewidth.

These predictions were verified by measurements from an example fiber optic gyroscope as shown schematically in FIG. 1. Measuring bias stability and angular random walk in units of °/h and °/√h, respectively, implicitly depends on the choice of scale factor. However, the loop length L and loop diameter D can often be selected independently (within limits) without significantly affecting either the bias stability or the ARW, which may result in ambiguity about the sensor performance since it can be unclear whether better bias stability or ARW are achieved by actual system improvements, or by simply increasing the loop diameter, for example. To avoid this ambiguity, the description herein uses units of rad for the bias stability and rad/√Hz for the random walk. Converting to optical gyroscope navigation units is accomplished easily by converting radians to degrees and dividing by the scale factor (in hours). Inertial navigation generally demands a bias stability of about 10⁻⁷ rad for typical scale factors, and excess noise for a typical optical gyroscope driven by a broadband source on the order of 10⁻⁶ rad/√Hz.

As discussed above, there are three significant sources of noise and drift in an optical gyroscope utilizing a laser source: Kerr-induced drift, polarization-induced drift, and backscattering. Each of these effects is discussed below.

### Kerr-Induced Drift

Interferometric optical gyroscopes, such as fiber optic gyroscopes (FOGs), measure rotation using the well-known Sagnac effect. With reference to FIG. 2, a coupler can be used to split incoming light, forming two beams of light that propagate around the same fiber coil in opposite directions. Upon exiting the loop, the two light beams are recombined via the same coupler and interfere. Ideally, under no rotation, both beams traverse identical optical paths and interfere constructively at the common input/output port. However, rotation breaks this symmetry, causing a differential phase shift between the two beams proportional to the rotation rate, as indicated in Eqs. 1 and 2.

If the coupler is not perfectly symmetric, then the fields propagating in each direction will no longer be equal in magnitude, leading to an additional source of non-reciprocal phase shift. This phase shift is caused by the nonlinearity of the propagation constant, and can be expressed as:

$${φ}_{\pm }^{k} = \frac{2 π}{λ} {n}_{2} L ( {I}_{\pm } + 2 {I}_{∓} ) \qquad ( 24 )$$

where n₂ represents the nonlinear coefficient of the fiber, k is the propagation constant, L is the fiber length I_{±} represent the optical intensity propagating in either the CW (+) and CCW (−) direction, respectively, and a single linear state of polarization is assumed throughout the fiber. The so-called self phase modulation term, or the additional phase due to the nonlinear effect of a signal on itself (first term in the right hand side of Eq. 24), is half of the cross-phase modulation term (second term). Thus, when the CW and CCW intensities do not match exactly, due to an imperfect coupler for example, the Kerr-induced phase shift on each signal is different, resulting in a differential phase shift between the counter-propagating signals given by:

$$Δ {φ}^{k} = {φ}_{+}^{k} - {φ}_{-}^{k} = \frac{2 π}{λ} {n}_{2} L ( {I}_{-} - {I}_{+} ) = \frac{2 π}{λ} {n}_{2} L ( 1 - 2 K ) {I}_{0} \qquad ( 25 )$$

where the last equality is obtained by assuming the coupler is lossless with a splitting ratio K and input intensity I₀.

Using typical values (λ=1.55 μm, n₂=3·10⁻¹⁴ μm²/μW for silica, I₀=1 μW/μm²), for a 5-km coil, a 1% intensity difference between counter-propagating signals results in a phase error of about 6 μrad. This error is almost two orders of magnitude higher than needed for inertial navigation devices.

This worst-case error assumes that the nonreciprocal Kerr-induced phase is accumulated during propagation through the entire loop length, which may not always be true. When two signals counter-propagate in a nonlinear medium, the nonreciprocal phase accumulation results from the formation of a nonlinear index grating caused by standing-wave interference between the counter-propagating fields. This implies that any mechanism that destroys the coherence of this standing wave will reduce the amount of nonreciprocal phase accumulated.

A method to reduce the Kerr-induced drift is therefore to use a source with a short coherence length. When the coherence length of the source is much shorter than the loop length, the length of fiber over which the nonreciprocal Kerr phase shift is accumulated is essentially reduced to twice the source coherence length, regardless of the loop length. The nonlinear index grating due to the interference has a high contrast only near the loop midpoint, while the contrast is quickly washed away at distances more than one coherence length from the midpoint. Thus for a source with a bandwidth of 10 MHz, or a coherence length of about 6.5 m in a solid-core fiber, the expected Kerr-induced error would be about 0.2·10⁻⁷ rad for any coil length longer than 13 m. This value is safely below inertial navigation requirements.

Kerr-induced errors can also be mitigated by selecting a fiber with a low nonlinear coefficient. For example, a hollow-core fiber can be used, which can reduce the Kerr-induced errors by about three orders of magnitude, depending on the fiber design, as compared to that of a solid-core fiber. Thus, though a coherent source can increase the risk of Kerr-induced errors, these errors can be reduced or minimized to meet desired stability levels (e.g., for inertial navigation). By using spectrally broader linewidths, Kerr-induced errors can be reduced to negligible levels. For narrow-linewidth sources, amplitude modulation or an appropriate choice of fiber can reduce such errors further.

### Polarization-Induced Drift

The latent birefringence of an optical fiber has the potential to destroy the reciprocity of the optical gyroscope, leading to large phase differences between counter-propagating signals. A typical single-mode fiber has two quasi-degenerate eigenmodes, each with an orthogonal state of linear polarization. When counter-propagating signals do not travel in the same state of polarization, they accumulate a differential phase shift that is indistinguishable from a rotation-induced phase shift. Furthermore, defects in the fiber as well as external perturbations can cause light in one polarization state to couple to the other polarization state. This coupling can change over time and can lead to drift.

The most obvious effect of this cross-polarization coupling can occur when light is launched into the input fiber with imperfect alignment relative to the fiber's polarization axes. Some light that is initially cross-polarized from the primary fields will be coupled into the same polarization as the primary fields. If this coupling occurs at a point zₒ in the fiber, then light traveling in one direction around the loop will accumulate phase as φ₁=β_{y}z₀+βₓ(L−z₀), while light traveling in the opposite direction will accumulate phase as φ₂=β_{y}(L−z₀)+βₓz₀, where βₓ and β_{y} are the propagation constants of the x and y polarized light, respectively. This results in a phase difference between the counter-propagating signals of Δφₑ=βₓ(L−2z₀)−β_{y}(L−2z₀).

Heuristically, the magnitude of this error can be quantified using the input light polarization extinction ratio (PER) and the fiber holding parameter h. PER is the ratio Pₓ/P_{y} of powers in the x and y polarization modes, generally specified in dB. The fiber holding parameter h is a measure of the expected power coupled from one polarization mode to the other in units of m⁻¹. For polarization maintaining (PM) fiber (e.g., fiber that has been designed with a high birefringence to minimize cross-coupling of power from one polarization to the other), a typical value of h is 10⁻⁵ m⁻¹, or 20 dB/km. Assuming a highly polarized source and precise alignment with the polarization axis of the common input/output fiber, an input PER might be 30 dB. Yet even with such alignment, the maximum phase error due to the cross-polarization mode coupling can be as high as:

|φₘₐₓ|<2\sqrt{hL·PER} (26)

which using the values above yields an error of about 10⁻² rad.

A “perfect” polarizer placed at the common input/output port can reduce or minimize the error by correcting for any misalignment between the source and the input fiber such that light exiting the loop travels a truly reciprocal path (at least with regards to polarization). Nevertheless, for a polarizer with a finite PER ε², some error can still exist. Using the heuristic model, the residual error, even with a polarizer, can be as high as

|φₘₐₓ<2ε\sqrt{hL·PER} (27)

Early fiber polarizers had extinction ratios on the order of 60 dB, reducing the residual error by three orders of magnitude, but still at least an order of magnitude higher than desired for inertial navigation applications. Modern developments in polarizers (e.g., using proton-exchanged LiNbO₃) have resulted in polarizers with extinction ratios in excess of 80 dB, which can reduce the expected error by at least another order of magnitude and can bring the error within reach of values desired for inertial navigation applications.

Other methods of reducing polarization errors exist. One method is to use an un-polarized source or a Lyot depolarizer to reduce the coherence between cross-polarized fields, such that any interference due to cross-coupling is reduced or minimized. Additionally, the high birefringence of PM fibers combined with the short coherence of broadband sources can act essentially as a depolarizer, effectively reducing or minimizing direct interference from cross-polarized light not originating within a depolarization length Lγ of either fiber end or the loop midpoint. Depolarization lengths for a broadband source are typically on the order of 10 cm, reducing polarization errors by another two orders of magnitude. Thus, for shorter loop lengths (e.g., on the order of hundreds of meters), polarization-induced errors in an optical gyroscope can be reduced to desired levels for inertial navigation applications by the high extinction ratio of modern polarizers. For longer coil lengths, use of a depolarizer may reduce errors further.

### Backscattering

Several factors can be used to reduce the expected errors due to backscattering down to levels desired for inertial navigation applications. As pointed out earlier, since only coherent backscattering causes significant errors, reducing the coherence length of the source can reduce the length of the loop that contributes to the coherent backscattering-induced errors. As another example, the modeling discussed herein shows that an appropriate choice of phase-modulation scheme, together with a phase-sensitive detection process, can significantly reduce remaining backscattering errors further. All modern optical gyroscopes use a phase modulation technique to provide a proper bias and improve the gyroscope sensitivity. This modulation can be supplied by placing a phase modulator in one of the arms of the Sagnac loop, close to the loop coupler. By selecting the phase modulation period to equal twice the loop delay, the phase modulation for achieving the proper biasing (that gives maximum sensitivity to rotation) is minimized.

A phase modulation much more beneficial to reducing the backscattering-induced noise and drift in laser-driven optical gyroscopes is the push-pull modulation in which two phase modulators are used, instead of one (e.g., with a first phase modulator near a first end of the loop and a second phase modulator near a second end of the loop). The two phase modulators are operated at the proper frequency of the Sagnac loop (fₘ=v/2L) and in the push-pull mode in which a first time-dependent phase modulation is applied by the first phase modulator and a second time-dependent phase modulation is applied by the second phase modulation. The second time-dependent phase modulation is substantially equal in amplitude and of opposite phase (e.g., 180 degrees out of phase) with the first time-dependent phase modulation applied by the first phase modulator.

This technique has several advantages in the context of optical gyroscopes. First, the voltage applied to each phase modulation is half the voltage that would be applied to the modulator in a gyroscope that uses a single modulator, because each signal picks up half the modulation at each modulator and these two halves add together. As a result, since the power is proportional to the voltage squared, the electrical power consumed by the two phase modulators is lower than the electrical power consumed by the single phase modulator. Second, if the response of the phase modulator is not linear, i.e., if the phase applied to the wave is proportional to the applied voltage plus a weaker second-order nonlinear term proportional to the voltage squared, this nonlinearity translates in an undesirable nonlinearity in the response of the gyroscope to a rotation. When using two phase modulators with nominally identical responses (and hence nonlinearity) in a push-pull configuration, the linear terms add (which is why only half the voltage is used), but the second-order nonlinear terms cancel out. A third benefit is that in the limit of a coherence length much shorter than the loop length, a push-pull modulation also reduces the weak residual error due to coherent backscattering.

In the context of the present application, a further advantage is that when using a laser to interrogate the optical gyroscope, the use of push-pull modulation has the result that signals backscattered in the CW and in the CCW directions are both modulated twice. In contrast, with a single modulator the fields backscattered in the CW direction (assuming that there is a phase modulator at port 4 in FIG. 2) is modulated once when they enter the loop and when they return as backscattered light, whereas the fields backscattered in the CCW direction are not modulated when they enter the loop (since there is no modulator at input port 3 in FIG. 2) and they are not modulated when they return as CCW backscattered light (since they exit through the same port 3 as they entered). Our simulations show that this asymmetry in the modulation of the interfering backscattered signals results in a sizeable backscattering error. In contrast, when the push-pull modulation is used, at the proper frequency (fₘ=v/2L), as explained above, the backscattered fields experience a symmetric modulation: fields backscattered from points that are symmetrically located with respect to the midpoint experience the same phase modulation. This symmetry allows significant cancellation of the backscattering-induced errors, particularly when the demodulation scheme is adjusted to extract only the portion of the output signal that is in-phase with the applied phase modulation.

This cancellation of the coherent-backscattering-induced errors is quite significant when the coherence length of the source is not negligible compared to the loop length. For example, when using push-pull modulation at the proper frequency, at least one of the noise and drift due to coherent backscattering can be reduced by at least a factor of 1.5, 2, 5, 10, 20, 50, 60, 100, 200, 500, 1000, or by one or more orders of magnitude (e.g., up to a few orders of magnitude) compared to the same gyroscope utilizing a single modulator (e.g., a configuration in which the first phase modulator and the second phase modulator are replaced by a single phase modulator; only a single time-dependent phase modulation is then applied to the first laser signal and to the second laser signal counter-propagating through the coil). In the experimental gyroscope reported herein, for example, the use of the push-pull modulation scheme was almost entirely responsible for the reduction by a factor of approximately 60 in the observed drift compared to that of an earlier optical gyroscope using the same components but with a single modulator (e.g., a configuration in which the first phase modulator and the second phase modulator are replaced by a single phase modulator; only a single time-dependent phase modulation was then applied to the first laser signal and to the second laser signal counter-propagating through the coil). This result is particularly important to reduce the drift to the sub-gad level for inertial navigation applications.

### Measurements

As discussed above, errors caused by the nonlinear Kerr effect, polarization effects, and coil backscattering, previously expected to make lasers unusable as a light source for optical gyroscopes (despite the wavelength stability of laser sources), can be reduced using modern components and specific engineering techniques designed to mitigate these effects. The description below describes measurements made to verify this result, using a fiber optic gyroscope with a typical broadband source and with several different laser sources.

FIG. 1 is a diagram of an optical gyroscope 10 in accordance with certain embodiments described herein, a version of which was used to make the measurements discussed below. The optical gyroscope 10 comprises a waveguide coil 20, a source 30 of laser light, an optical detector 40, and an optical system 50 in optical communication with the source 30, the optical detector 40, and the coil 20. The optical system 50 comprises a first phase modulator 52 in optical communication with a first portion 22 of the coil. The optical system 50 further comprises a second phase modulator 54 in optical communication with a second portion 24 of the coil 20. The optical system 50 further comprises at least one polarizer 60 in optical communication with the first phase modulator 52 and the second phase modulator 54. A first portion 32 of laser light propagates from the source 30, through the optical system 50, through the coil 20 in a first direction, then through the optical system 50 to the detector 40. A second portion 34 of laser light propagates from the source 30, through the optical system 50, through the coil 20 in a second direction opposite to the first direction, then through the optical system 50 to the detector 40.

The waveguide coil 20 can comprise an optical waveguide such as an optical fiber, examples of which include but are not limited to a high birefringence polarization-maintaining (PM) fiber. Such fibers are available from a number manufacturers, including Corning, Inc., FiberCore, Newport, etc. The coil 20 can comprise a plurality of loops that are substantially concentric with one another. For example, the measurements described below were obtained using a coil 20 comprising a high birefringence PM solid-core fiber having a length of 150 m and that was quadrupolar wound in a plurality of substantially concentric loops having a diameter of 3.5 cm. The first portion 22 of the coil 20 can comprise an end portion of the coil 20 that is coupled (e.g., spliced) to the optical system 50, and the second portion 24 of the coil 20 can comprises an end portion of the coil 20 that is coupled (e.g., spliced) to the optical system 50. The coil 20 can be enclosed in a container to reduce ambient thermal and acoustic perturbations.

The source 30 can be configured to provide laser light at a desired wavelength. For example, for the measurements described below, each source 30 emits continuous radiation at a nominal center wavelength of 1.55 μm. The source can be fiber pigtailed to facilitate assembly. The detector 40 can comprise one or more photodetectors responsive to light having the wavelength of the source 30.

The optical system 50 can comprise a multi-function LiNbO₃ integrated optical circuit (MIOC) 51 which is in optical communication with the coil 20. The MIOC 51 can comprises the first phase modulator 52, the second phase modulator 54, a loop coupler 56 (e.g., a coupler configured to close the coil 20 upon itself), and the at least one polarizer 60, as schematically illustrated in FIG. 1. In certain embodiments, the optical system 50 comprises at least one input/output coupler 70 (e.g., a 2×2 coupler or a 50% fiber coupler). Some or all of these various components can be achieved through either an all-fiber approach or by using integrated optics (e.g., the MIOC 51) to combine the functions of the some or all of these various components in a single unit.

The segments of fiber connecting the laser source to the coupler, and connecting the coupler to the MIOC, can all be polarization-maintaining fibers, with their principal axes carefully aligned with the axes of the laser source and of the MIOC to maximize the power coupled into the main eigenpolarization of the sensing coil's PM fiber. This configuration can minimize the residual power coupled into the unwanted eigenpolarization orthogonal to the main eigenpolarization, and therefore can minimize the noise and drift due to polarization coupling in the sensing coil described above.

The first phase modulator 52 and the second phase modulator 54 can be operated in a push-pull configuration. The first and second phase modulators 52, 54 can be driven (e.g., with a sinusoidal waveform) at the proper loop frequency (e.g., 666 kHz for the 150-m coil) with a modulation depth of roughly 0.46 rad for maximum sensitivity.

In the measurements described below, the optical gyroscope 10 was tested with the three different laser sources 30: (A) a narrow 2.2-kHz linewidth laser from Redfern Integrated Optics, Inc. of Santa Clara, Calif., (B) a 200-kHz linewidth laser from Santec of Aichi, Japan, and (C) a 10-MHz distributed feedback (DFB) telecom laser from Mitsubishi Electric Corporation of Tokyo, Japan.

For each source 30, the random walk and drift were calculated using the Allan variance method which is a statistical method frequently used for measuring gyroscope performance. Rather than a single point measurement of performance, Allan variance is typically presented as a log-log plot capturing short term noise, long-term bias instability, and other sources of dynamic error. Though referred to as the Allan variance (AV), AV curves generally feature the Allan deviation as the ordinate, and time-constant or integration time as the abscissa. When plotted in this manner, different noise sources are easily identifiable. For shorter time constants, the AV plot generally has a slope of −½, indicating sensor performance dominated by white, or random walk noise. For longer time constants, the AV plot will generally reach an inflection point and flatten out, with a slope of zero. This indicates bias instability, and the Allan deviation at the minimum can be taken as a measure of bias stability. For even longer time constants, the Allan variance may in fact increase with a slope of +½. This indicates rate random walk (RRW) and is a sign of greater instability in the sensor output.

For each of the three lasers used, two measurements were performed to generate a composite Allan variance plot. The first measurement was typically captured over a fifteen minute period at a higher sampling rate (about 100 Hz). The optical gyroscope 10 was driven at the loop proper frequency (fₘ=v/2L), which has several advantages including the reduction of coherent backscattering errors when a typical phase-sensitive detection process is used, as described earlier. The output was also demodulated using a lock-in amplifier synchronized to the modulation frequency. In making these measurements, the reference phase of the lock-in amplifier was carefully adjusted to extract only the portion of the output signal that is in-phase with the applied phase modulation. The lock-in integration time was chosen to ensure that no portion of the signal is aliased when sampling at the chosen rate.

The second measurement was taken over a longer period, generally 12 hours with a slower sampling rate (about 2 Hz). For this longer measurement, the sampling rate was reduced (e.g., to about 1 Hz) and the bandwidth of the lock-in amplifier was similarly adjusted to avoid aliasing while also reducing the volume of data collected. For both measurements, the optical gyroscope 10 was in a largely uncontrolled environment, although the coil 20 was placed inside a container that provided some thermal and acoustic isolation. The coil 20 was maintained at rest in the laboratory environment, and for the purpose of these measurements it was positioned with its main axis orthogonal to the Earth's axis of rotation. In addition, the linearly polarized input light was aligned with the polarization axes of the fiber coil.

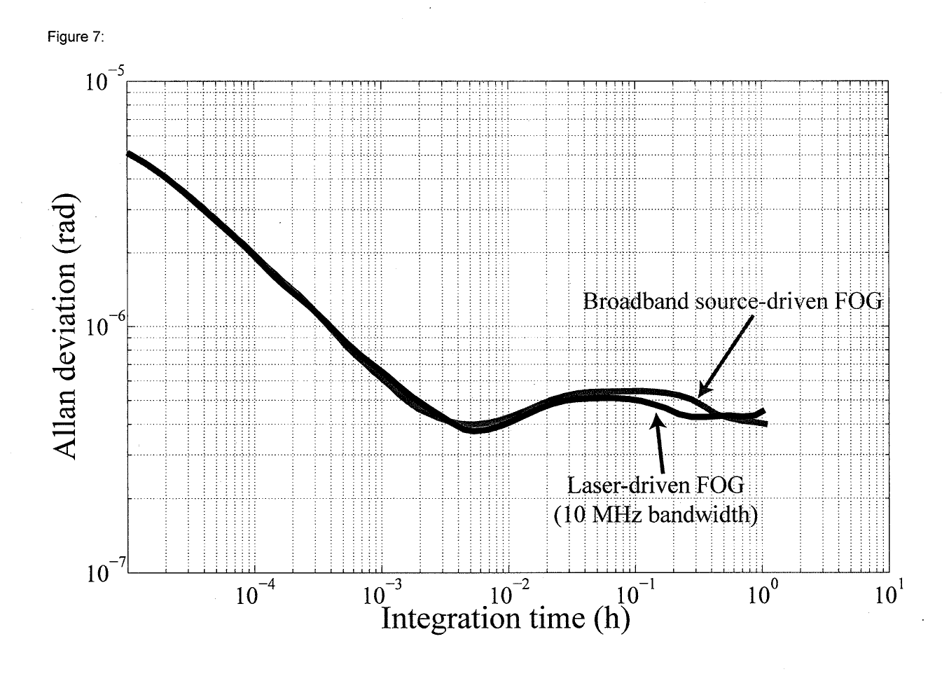

Once data from both measurements were collected, the data were processed using a standard Allan variance algorithm. The two separate Allan variance plots were then combined to form a single plot covering integration times ranging from 10⁻⁵ h to 10 h. FIG. 7 shows an example of one such plot for the 10-MHz bandwidth DFB laser, along with that from a conventional erbium-doped broadband superfluorescent source (SFS).

While the measurements were performed under comparable conditions with both the laser and broadband sources, the measurements for the optical gyroscope 10 with the laser source included minimizing any discrete reflections at interfaces (e.g., splices between the fiber coil and the MIOC). In addition, the input light polarization was precisely aligned with the birefringence axes of the fiber coil 20. When such care is taken, the results (FIG. 7) show that the gyroscope exhibits very similar characteristics regardless of the source. For shorter time constants (<3×10⁻³ h), the Allan deviation has a slope of −½, indicating that in this range the performance is limited by the ARW. For longer time constants, the Allan deviation flattens out to a slope of essentially zero, which indicates bias instability. As FIG. 7 shows, the laser-driven and SFS-driven optical gyroscopes exhibit almost identical drift performance. This similarity strongly suggests that at this stage the limiting performance factor is not the source itself—in particular neither coherent backscattering nor, importantly, the Kerr effect (even though a laser is used) appear to be limiting the performance. This also explains why the lowest measured drift in FIG. 4B is closest to the predicted upper bound, since this measurement reflects sources of error other than backscattering. Closed-loop techniques should further improve the performance with either source.

As shown in FIG. 7, both the laser-driven optical gyroscope and the broadband-driven optical gyroscope exhibit almost identical performances across the range of integration times shown in FIG. 7. This result indicates that for this optical gyroscope 10, the bias stability is most likely not limited by coherent effects, but by some effect independent of the optical source properties. Since the measurements were made only for open-loop signal processing, the most likely source of bias instability is in the electronic components used to modulate and demodulate the optical signal via the phase modulators. A closed-loop signal processing system can be configured to reduce this electronic drift and lower the overall observed sensor drift.

As discussed above, the slope of the curve at shorter integration times indicates the random walk noise of the optical gyroscope 10, which in this case is about 1 μrad/√Hz. In addition, for longer time constants, the magnitude of the slope of the curve drops, eventually flattening out. For the 10-MHz bandwidth DFB laser, the minimum of the Allan variance plot occurs at about 0.4 μrad, representing the bias stability of the laser-driven optical gyroscope 10 with this source 30. Similar plots were also generated for the two other lasers (2.2-kHz and 200-kHz linewidth, respectively).

From each of the Allan variance plots, the random walk noise and the drift were extracted, and are shown in FIG. 4A and FIG. 4B, respectively (shown by the solid circles). The solid lines in these figures are the calculated noise and drift from the theoretical model discussed above. Both the noise (FIG. 4A) and drift (FIG. 4B) measured with lasers of different linewidths track the theoretical calculations. The largest noise of 7 μrad/√Hz was observed with the 200-kHz linewidth laser, as predicted by the theoretical description above since this linewidth corresponds to a coherence length (330 m inside the fiber) near the loop length. The noise was significantly lower for a laser having a coherence length either much shorter or much longer than the loop length. The lowest noise, observed with the 2.2-kHz-linewidth laser (L_{c}≈30.1 km inside the fiber), was as low as 0.35 μrad/√Hz, or about 3.5 times lower than in the same optical gyroscope 10 operated with an SFS. This result was the first demonstration of an optical gyroscope with a noise floor well below the excess-noise limit and near the shot-noise limit. FIG. 4B shows that the measured drift values are also at or below the theoretically calculated upper bound limit. The observed drift increases with increasing coherence length, with the highest drift (10 μrad) obtained with the 2.2-kHz-linewidth laser. The drift was reduced to 0.4 μrad with the 10-MHz linewidth laser.

As explained above, the calculated drift represents an upper bound for the drift due to backscattering alone, while the calculated noise is the noise calculated to be due to backscattering. The measured values are in good agreement with the calculated values, confirming the predictions of the effects of backscattering in an optical gyroscope.

At 1 μrad/√Hz, the observed noise of the laser-driven optical gyroscope 10 is comparable to typical noise levels for broadband-source driven optical gyroscopes. Furthermore, the measured drift of 0.4 μrad is the first reported experimental observation of a laser-driven optical gyroscope 10 with drift at levels (about 0.1 μrad) desired for inertial navigation applications. This measured drift includes not only drift caused by backscattering, but also any additional components of drift caused by the polarization and nonlinear Kerr effects discussed above. This measurement therefore verifies that errors due to these effects can be significantly reduced through the combination of modern components, an appropriate choice of laser linewidth, and in accordance with certain embodiments described herein.

### Laser-Driven Hollow-Core Optical Gyroscope

In certain embodiments, the waveguide coil 20 can comprise a hollow-core fiber (HCF). An HCF can introduce two benefits over a solid-core fiber, namely a reduction in both the Kerr-induced drift and the thermal drift (also known as the Shupe effect). Both improvements stem from the fact that in an HCF, most of the energy of the fundamental core mode is confined in air, which has both a much weaker nonlinear Kerr constant and a lower refractive-index dependence on temperature. The HCF can advantageously be polarization maintaining.

Numerical simulations have established that the Kerr constant is about 250 times lower in a 7-cell HCF (NKT's HC-1550-02 fiber), and a factor of least 1000 is expected in a 19-cell HCF. In a hollow-core optical gyroscope, the resulting reduction in Kerr-induced drift is commensurate with these figures. This point was verified in an optical gyroscope with a sensing coil made of 235 m of 7-cell HCF, interrogated by a 200-kHz DFB laser. Even when the laser power was as high as 50 mW and the coupling ratio purposely imbalanced to 10%, the measured Kerr-induced offset was well below the noise (about 90 μrad). Under typical conditions (an input power of 200 μW and a coupling ratio of 50%±2%), this optical gyroscope has a calculated nonlinear drift of less than 9.7 nrad/s, and it easily meets the RNP-10 criterion for a 10-h flight for inertial navigation. These measurements confirmed that if need be, an HCF can be used to essentially eliminate the residual Kerr-induced drift in a laser-driven optical gyroscope.

Simulations and measurements of the thermally induced phase change agreed that the Shupe constant is about 7.5 times lower in an HC-1550-02 fiber than in an SMF-28 fiber. This significant reduction was confirmed by applying a temperature gradient to the quadrupolar-wound coil of a hollow-core optical gyroscope and measuring a 6.5-fold reduction in Shupe-induced drift compared to a solid-core optical gyroscope. While the Shupe effect can be largely mitigated through careful packaging, by reducing this effect itself an HCF adds value by relaxing the constraints on some of these engineering solutions.

A disadvantage of at least some HCFs in optical gyroscopes is the increased scattering coefficient over an SMF-28 fiber, as is the case of the NKT's 7-cell HCFs. The noise and offset due to coherent backscattering, which scale like √α_{B}, are therefore expected to be higher. In a previously-studied hollow-core optical gyroscope, the noise was indeed found to be about 10 times higher than in a solid-core optical gyroscope. However, backscattering in an HCF is dominated by random defects at the surface of the fiber core. Since the statistics of such defects are expected to be different from that of Rayleigh scattering, a study of this type of scattering would be helpful before concluding that the two mechanisms yield the same level of error in an optical gyroscope. Possible noise and drift reduction can be explored with (1) a 19-cell fiber, which has much lower loss and hence likely much lower backscattering, (2) improved fiber design, and (3) reduced fiber loss.

A second difficulty is spurious Fresnel reflections. Because HCF couplers do not yet exist, the HCF can be spliced to the pigtail of a conventional fiber coupler or of an MIOC to form the optical gyroscope's optical circuit. A splice produces a reflected signal, albeit weak. This problem is much less severe in solid-core optical gyroscopes because the reflections are considerably weaker and splicing between dissimilar fibers can be avoided. In an HCF optical gyroscope, the problem can be readily minimized by splicing the fibers at an angle. Also, because the splices are located near the loop coupler, by choosing a laser with a short enough coherence length (L_{c}≦L), a solution that also reduces the coherent backscattering noise and drift as discussed above, the reflections lead to intensity noise only and result in much weaker noise and drift.

### Measurement Considerations

Stable AV curves can advantageously be obtained by a method comprising adjusting the input state of, polarization (SOP), adjusting the phase modulation frequency using square-wave modulation, switching back to sinusoidal modulation, and adjusting the phase to null changes to an out-of-phase component in the presence of rotation.

Square-wave modulation can advantageously be used in producing a closed loop system. Square-wave modulation can advantageously be used also to reduce the noise of the system by reducing the average detected power at the modulation frequency absent rotation.

The use of a PM fiber in the sensing coil of the optical gyroscope was advantageous in achieving the performance shown in FIG. 7 (the use of a non-PM single-mode fiber such as Corning's SMF-28 fiber produced higher noise and drift). A possible explanation is that because the two fiber pigtails of the MIOC 51 on the coil side of the MIOC 51 comprised PM fiber, when the coil 20 comprised SMF-28 fiber, this fiber was spliced to the two PM fiber pigtails, and these two splices between dissimilar fibers produced stronger back-reflections, which resulted in increased coherent errors. When the optical gyroscope uses PM fiber as the coil 20, the PM-fiber coil can be directly optically coupled to the MIOC 51, e.g., there were no splices, and no additional back-reflections.

Differences from previous work (e.g., U.S. Pat. Appl. Publ. 2010/0302548A1, which is incorporated in its entirety by reference herein) includes the modeling of push-pull modulation, the use of PM fiber, rather than SMF-28 fiber or air-core fiber, and the use of a shorter coil (e.g., 150 m for the PM fiber, as opposed to 230 m for the SMF-28 fiber). In terms of noise, the coil length and the fiber properties have more effect than does the push-pull modulation. As mentioned earlier, the push-pull modulation scheme is almost exclusively the factor driving the observed about 60-fold reduction in the drift. The coil length and fiber properties have some effect, but it is small compared to that due to the modulation.

As shown by the analytic model and numerical techniques described herein, the random walk noise due to backscattering can be drastically reduced by using a coherent light source (a laser) with an appropriate choice of coherence length, either a short coherence length or a long coherence length relative to the loop length. The demonstration that the noise can be reduced by using a coherence length much longer than the loop length has not been demonstrated before. It has important implications for building high-accuracy, energy-efficient optical gyroscopes with a high scale-factor stability.

The analytic and numerical tools presented are also useful for predicting the effects of the long-term drift due to coherent backscattering in interferometric optical gyroscopes. The bias can be reduced for high coherence sources by careful control of the loop coupler and phase modulation frequency. However, errors in either the coupling coefficient or the modulation frequency can quickly lead to a relatively large bias error. For applications in inertial navigation systems, an optical gyroscope driven with a high-coherence source may be used with stabilization of the optical path in order to guarantee the desired performance. One possible method of stabilization would be to use an air-core fiber as the sensing coil, leading to less sensitivity to environmental stimuli like temperature gradients and magnetic fields. For some applications where the random walk is of greater importance, an interferometric optical gyroscope with a high-coherence source can be a viable option.

In a regime in which the coherence length is shorter than the loop length, yet significantly longer than traditional broadband sources, the source coherence length can be chosen to reduce backscattering noise below the excess noise of a broadband source, while still maintaining a high scale-factor stability. Significantly, the long-term drift predicted in this regime also approaches the level desired for tactical-grade devices, suggesting a strong competitor to the traditional approach of a fiber optic gyroscope driven by a broadband source.

The negative effects of coherent backscattering associated with the use of a laser in an optical gyroscope are several orders of magnitude lower than previously predicted. Using modern components, a symmetric modulation scheme, an appropriate laser linewidth, and careful adjustment of the gyroscope settings, a laser-driven optical gyroscope with short-term and long-term (e.g., about 1 hour) performance matching that of an optical gyroscope driven with a broadband source. These achievements come with the many benefits of laser light, most notably a high wavelength stability, which for the first time positions the laser as a viable source for high-accuracy optical gyroscopes. The additional use of a hollow-core fiber introduces further benefits, including reduced Kerr-induced and thermal drifts, although currently at the expense of increased backscattering.

Various embodiments of the present invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A method of reducing coherent backscattering-induced errors in an output of an optical gyroscope, the method comprising:
splitting laser light into a first laser signal and a second laser signal;
applying a first time-dependent phase modulation to the first laser signal to produce a phase-modulated first laser signal;
applying a second phase modulation to the second laser signal to produce a phase-modulated second laser signal, the second time-dependent phase modulation substantially equal in amplitude and of opposite phase with the first time-dependent phase modulation;
propagating the phase-modulated first laser signal in a first direction through a waveguide coil;
propagating the phase-modulated second laser signal in a second direction through the waveguide coil, the second direction opposite to the first direction;
applying the first time-dependent phase modulation to the phase-modulated second laser signal after the phase-modulated second laser signal propagates through the waveguide coil to produce a twice-phase-modulated second laser signal;
applying the second time-dependent phase modulation to the phase-modulated first laser signal after the phase-modulated first laser signal propagates through the waveguide coil to produce a twice-phase-modulated first laser signal; and
transmitting the twice-phase-modulated first laser signal and the twice-phase-modulated second laser signal to a detector.

2. The method of claim 1, wherein the laser light has a linewidth less than 10⁸ Hz.

3. The method of claim 1, wherein the laser light has a linewidth less than 10¹¹ Hz.

4. The method of claim 1, wherein the waveguide coil comprises a Sagnac loop, and the first time-dependent phase modulation and the second time-dependent phase modulation are performed at a frequency equal to the effective phase velocity of a fundamental mode of the Sagnac loop divided by twice the length of the Sagnac loop.

5. The method of claim 1, wherein at least one of the coherent-backscattering-induced noise and drift in an output of the detector are reduced by at least one or more orders of magnitude compared to the output of the detector with only a single time-dependent phase modulation applied to the first laser signal and to the second laser signal.

6. The method of claim 1, wherein at least one of the coherent-backscattering-induced noise and drift in an output of the detector are reduced by at least a factor of 1.5 compared to the output of the detector with only a single time-dependent phase modulation applied to the first laser signal and to the second laser signal.

7. The method of claim 1, wherein at least one of the coherent-backscattering-induced noise and drift in an output of the optical gyroscope is reduced by at least a factor of 60 compared to the output of the detector with only a single time-dependent phase modulation applied to the first laser signal and to the second laser signal.

8. An optical gyroscope comprising:
a waveguide coil;
a source of laser light;
an optical detector; and
an optical system in optical communication with the source, the optical detector, and the coil, such that a first portion of laser light propagates from the source, through the optical system, through the coil in a first direction, then through the optical system to the detector, and a second portion of laser light propagates from the source, through the optical system, through the coil in a second direction opposite to the first direction, then through the optical system to the detector, the optical system comprising:
a first phase modulator in optical communication with a first portion of the coil and configured to apply a first time-dependent phase modulation; and
a second phase modulator in optical communication with a second portion of the coil and configured to apply a second time-dependent phase modulation that is substantially equal in amplitude and of opposite phase with the first time-dependent phase modulation; and
at least one polarizer in optical communication with the first phase modulator and the second phase modulator.

9. The optical gyroscope of claim 8, wherein the source of laser light has a linewidth less than 10⁸ Hz.

10. The optical gyroscope of claim 8, wherein the source of laser light has a linewidth less than 10¹¹ Hz.

11. The optical gyroscope of claim 8, wherein the optical system further comprises at least one first optical coupler in optical communication with the at least one polarizer, the first phase modulator, and the second phase modulator, wherein the at least one first optical coupler receives laser light propagating through a waveguide portion towards the coil, transmits the first portion of laser light to the first phase modulator, transmits the second portion of laser light to the second phase modulator, and directs the first portion and the second portion, after having propagated through the coil, onto the waveguide portion.

12. The optical gyroscope of claim 8, wherein the optical system further comprises at least one second optical coupler in optical communication with the source and the optical detector, wherein the at least one second optical coupler comprises a first port configured to receive laser light from the source, a second port configured to transmit the laser light towards the coil, and a third port configured to transmit the first portion of laser light and the second portion of laser light to the optical detector.

13. The optical gyroscope of claim 8, wherein the coil and the optical system form a Sagnac loop, and the first phase modulator and the second phase modulator are operated at a frequency equal to the effective phase velocity of a fundamental mode of the Sagnac loop divided by twice the length of the Sagnac loop.

14. The optical gyroscope of claim 8, wherein at least one of the coherent-backscattering-induced noise and drift in an output of the optical gyroscope are reduced by one or more orders of magnitude compared to a configuration in which only a single phase modulator is used.

15. The optical gyroscope of claim 8, wherein at least one of the coherent-backscattering-induced noise and drift in an output of the optical gyroscope are reduced at least by a factor of 1.5 compared to a configuration in which only a single phase modulator is used.

16. The optical gyroscope of claim 8, wherein drift in an output of the optical gyroscope is reduced by at least a factor of 60 compared to a configuration in which only a single phase modulator is used.
